(19) United States
(12) Patent Application Publication
(10) Pub. No.: US 2013/0011608 A1
(43) Pub. Date: Jan. 10, 2013

(54) OPTICAL FILMS WITH MICROSTRUCTURED LOW REFRACTIVE INDEX NANOVOIDED LAYERS AND METHODS THEREFOR

(76) Inventors: Martin B. Wolk, Woodbury, MN (US); William Blake Kolb, West lakeland, MN (US); Encai Hao, Woodbury, MN (US); Michael Benton Free, Saint Paul, MN (US); Audrey A. Sherman, Saint Paul, MN (US); John A. Wheatley, Lake Elmo, MN (US); David S. Thompson, West Lakeland, MN (US); Matthew S. Stay, Saint Paul, MN (US)

(21) Appl. No.: 13/521,121

(22) PCT Filed: Jan. 13, 2011
(86) PCT No.: PCT/US2011/021053

§ 371 Date: Jul. 9, 2012

Related U.S. Application Data
(60) Provisional application No. 61/294,577, filed on Jan. 13, 2010.
(60) Provisional application No. 61/294,600, filed on Jan. 13, 2010.
(60) Provisional application No. 61/294,610, filed on Jan. 13, 2010.
(60) Provisional application No. 61/405,128, filed on Oct. 20, 2010.

(51) Int. Cl. B32B 3/30; B05D 3/06; B05D 3/12; B82Y 20/00

(52) U.S. Cl. 428/141; 427/359; 427/510; 977/932

(57) ABSTRACT

A microstructured article includes a nanovoided layer having opposing first and second major surfaces, the first major surface being microstructured to form prisms, lenses, or other features. The nanovoided layer includes a polymeric binder and a plurality of interconnected voids, and optionally a plurality of nanoparticles. A second layer, which may include a viscoelastic layer or a polymeric resin layer, is disposed on the first or second major surface. A related method includes disposing a coating solution onto a substrate. The coating solution includes a polymerizable material, a solvent, and optional nanoparticles. The method includes polymerizing the polymerizable material while the coating solution is in contact with a microreplication tool to form a microstructured layer. The method also includes removing solvent from the microstructured layer to form a nanovoided microstructured article.

### CROSS REFERENCE TO RELATED APPLICATIONS

This application claims the benefit of the following pending U.S. Provisional Applications, all of which were filed Jan. 13, 2010, and the disclosures of which are all incorporated herein by reference: 61/294,577, “Microstructured Low Refractive Index Article Process”; 61/294,600, “Microstructured Low Refractive Index Articles”; and 61/294,610, “Microstructured Low Refractive Index Viscoelastic Articles”. This application also claims the benefit of U.S. Provisional Application No. 61/405,128, “Optical Films with Microstructured Low Refractive Index Nanovoided Layers and Methods Therefor”, filed on Oct. 20, 2010, the disclosure of which is incorporated herein by reference.

### FIELD OF THE INVENTION

This invention relates generally to microstructured optical films, articles and systems that incorporate such films, and methods pertaining to such films.

### BACKGROUND

Articles having a structure of nanometer sized pores or voids can be useful for several applications based on optical, physical, or mechanical properties provided by their nanovoided composition. For example, a nanovoided article includes a polymeric solid network or matrix that at least partially surrounds pores or voids. The pores or voids are often filled with gas such as air. The dimensions of the pores or voids in a nanovoided article can generally be described as having an average effective diameter which can range from about 1 nanometer to about 1000 nanometers. The International Union of Pure and Applied Chemistry (IUPAC) have provided three size categories of nanoporous materials: micropores with voids less than 2 nm, mesopores with voids between 2 nm and 5 nm, and macropores with voids greater than 50 nm. Each of the different size categories can provide unique properties to a nanovoided article.

Several techniques have been used to create porous or voided articles, including for example polymerization-induced phase separation (PIPS), thermally-induced phase separation (TIPS), solvent-induced phase separation (SIPS), emulsion polymerization, and polymerization with foaming/blowing agents. Often, the porous or voided article produced by these methods requires a washing step to remove materials such as surfactants, oils, or chemical residues used to form the structure. The washing step can limit the size ranges and uniformity of the pores or voids produced. These techniques are also limited in the types of materials that can be used.

### BRIEF SUMMARY

We describe herein, among other things, microstructured articles that include a nanovoided layer and a polymeric resin layer. The nanovoided layer has a microstructured first major surface and a second major surface opposing the first major surface. The nanovoided layer also comprises a polymeric binder and a plurality of interconnected voids. The polymeric resin layer is disposed on the microstructured first major surface or on the second major surface.

In some cases, the nanovoided layer may further include nanoparticles. In some cases, the nanoparticles may include surface modified nanoparticles. In some cases, the nanovoided layer may have an index of refraction in a range from 1.15 to 1.35. In some cases, the polymeric binder may be formed from a multifunctional acrylate and a polyurethane oligomer. In some cases, the microstructured first major surface may comprise cube corner structures, lenticular structures, or prism structures. In some cases, the article may include outer major surfaces that are co-parallel. In some cases, the polymeric resin layer may transmit visible light. In some cases, the polymeric resin layer may be disposed on the microstructured first major surface, and may comprise a polymeric material that penetrates into the nanovoided layer. In some cases, the polymeric resin layer may be a viscoelastic layer. In some cases, the viscoelastic layer may include a pressure sensitive adhesive.

In some cases, the article may also include an optical element disposed on the polymeric resin layer or the nanovoided layer. In some cases, the polymeric resin layer may be disposed on the microstructured first major surface and may form a coincident interface with the microstructured first major surface. In some cases, the article may also include an optical element disposed on the second major surface, and the optical element may include a retroreflective, refractive, or diffractive element, and/or the the optical element include a multilayer optical film, a polarizing layer, a reflective layer, a diffusing layer, a retarder, a liquid crystal display panel, or a light guide. In some cases, the optical element is an optical resin. In some cases, the second major surface may be substantially flat. In some cases, the second major surface may be microstructured. In some cases, the microstructured first major surface may have associated therewith a structure height of at least 15 micrometers and an aspect ratio greater than 0.3, and the nanovoided layer may have a void volume fraction in a range from 30 to 55%. In some cases, the microstructured first major surface may have associated therewith a structure height of at least 15 micrometers and an aspect ratio greater than 0.3, and the nanovoided layer may have a refractive index in a range from 1.21 to 1.35.

We also describe microstructured articles that include a nanovoided layer and a polymeric resin layer that is disposed on a microstructured first major surface of the nanovoided layer. The nanovoided layer includes a polymeric binder and a plurality of interconnected voids. The polymeric resin layer includes a polymeric material that penetrates into the nanovoided layer.

In some cases, the polymeric material may be a viscoelastic material. In some cases, the microstructured first major surface may include cube corner structures, lenticular structures, or prism structures. In some cases, the nanovoided layer may be characterized by an average void diameter, and penetration of the polymeric material into the nanovoided layer may be characterized by an interpenetration depth in a range from 1 to 10 average void diameters. In some cases, penetration of the polymeric material into the nanovoided layer may be characterized by an interpenetration depth of no more than 10 micrometers. In some cases, the microstructured first major surface may be characterized by a feature height, and penetration of the polymeric material into the nanovoided layer may be characterized by an interpenetration depth of no more than 25% of the feature height.

We also describe microstructured articles that include a nanovoided layer and an inorganic layer disposed on a microstructured first major surface of the nanovoided layer, or on a second major surface of the nanovoided layer. The nanovoided layer comprises a polymeric binder and a plurality of interconnected voids.

In some cases, the inorganic layer may comprise silicon nitride (SiN).

We also describe methods that include: disposing a coating solution onto a substrate, the coating solution comprising a polymerizable material and a solvent; polymerizing the polymerizable material while the coating solution is in contact with a microreplication tool to form a microstructured layer; and removing solvent from the microstructured layer to form a nanovoided microstructured article.

In some cases, the coating solution may also comprise nanoparticles. In some cases, the microstructured layer may comprise at least 10 wt % solvent. In some cases, the polymerizable material may comprise a multifunctional acrylate and a polyurethane oligomer. In some cases, the substrate may be a light transmissive film, the coating solution may further include a photoinitiator, and the polymerizing may include transmitting light through the substrate while the coating solution is in contact with the microreplication tool. In some cases, the nanovoided microstructured article may have a refractive index in a range from 1.15 to 1.35. In some cases, the removing may occur when the microstructured layer is no longer in contact with the microreplication tool. In some cases, the removing may include heating the microstructured layer to remove the solvent. In some cases, the disposing, polymerizing, and removing may be part of a continuous roll-to-roll process. In some cases, the nanovoided microstructured article may have a microstructured surface characterized by a structure height of at least 15 micrometers and an aspect ratio greater than 0.3, and the coating solution may have a wt % solids in a range from 50 to 70%.

Related methods, systems, and articles are also discussed. These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic diagram of an illustrative process of forming a nanovoided microstructured article;

FIG. 2 is a schematic diagram of an illustrative process of forming a backfilled nanovoided microstructured article;

FIG. 3 is a schematic side elevational view of a portion of a nanovoided microstructured layer;

FIGS. 3b and 3d are schematic cross-sectional views of a structured surface between a nanovoided layer and another layer, and FIGS. 3a and 3c are magnified cross-sectional views of the interface area of those structured surfaces respectively;

FIG. 4 is a schematic side elevational view of a nanovoided microstructured article;

FIG. 5 is a schematic side elevational view of a backfilled nanovoided microstructured article;

FIGS. 6-9 are a schematic side elevational views of other backfilled nanovoided microstructured articles;

FIGS. 10a-c are top view micrographs of microstructured nanovoided articles laminated with an adhesive;

FIG. 11a is an illustration that shows how an arc of circle can be defined, and FIG. 11b is an illustration that shows how that defined arc can be used to define a three-dimensional bullet-like shape useable as an element of a structured surface;

FIGS. 12a-f are perspective view low resolution SEM images of microstructured nanovoided articles of different compositions;

FIGS. 13a-c are high resolution SEM images of another microstructured nanovoided article;

FIGS. 14a-c are SEM images of further microstructured nanovoided articles of different compositions;

FIGS. 15a-c are top view SEM images of further microstructured nanovoided articles;

FIGS. 16a-c are TEM images of an interface between a nanovoided material and a pressure sensitive adhesive material at various magnifications;

FIGS. 17a-c are SEM images of the sample of FIGS. 16a-c at various magnifications; and

FIG. 18 is an enlarged view of FIG. 17c, showing that the PSA material has penetrated into the surface of the nanovoided material layer.

In the figures, like reference numerals designate like elements.

### DETAILED DESCRIPTION OF ILLUSTRATIVE EMBODIMENTS

Aspects of the present disclosure relate to microstructured low refractive index articles. A microstructured article may, for example, include a nanovoided layer and another layer. The nanovoided layer has opposing first and second major surfaces, and it includes a polymeric binder, a plurality of interconnected voids, and optionally a plurality of nanoparticles. The first major surface of the nanovoided layer is microstructured. The another layer may be disposed on the first or second major surface of the nanovoided layer, and the another layer may for example be or include a viscoelastic layer (such as a pressure sensitive adhesive) or a polymeric resin layer. The microstructured article may be in the form of a film or film article.

In some cases, the microstructured first major surface of the nanovoided layer is advantageously embedded within the microstructured article, thus providing at least some protection from handling-related damage, while allowing it to redirect or otherwise manage light as desired. In some cases, the nanovoided layer may have a low refractive index (e.g., from 1.15 to 1.45, or 1.15 to 1.4, or 1.15 to 1.35, or 1.15 to 1.3) such that the nanovoided layer behaves optically like a layer of air but mechanically like any other solid layer that can be used to attach other layers of the article together.

Other aspects of the disclosure relate to methods or processes for making microstructured low refractive index articles. Exemplary processes may include polymerizing or curing a coating solution that includes a solvent and polymer material while the coating solution is in contact with a microreplication tool to form a microstructured layer. Then solvent is removed from the microstructured layer so as to form a nanovoided microstructured article. The process can form films and other articles in which the microstructured surface, which provides the article with a desired optical functionality, is embedded within the article. The nanovoided layer may have a low refractive index layer (e.g., from 1.15 to 1.45, or 1.15 to 1.4, or 1.15 to 1.35, or 1.15 to 1.3) such that the nanovoided layer behaves optically like a layer of air but mechanically like any other solid layer that can be used to attach other layers of the article together. Microstructuring the nanovoided layer and embedding it within a film article can provide numerous advantages.

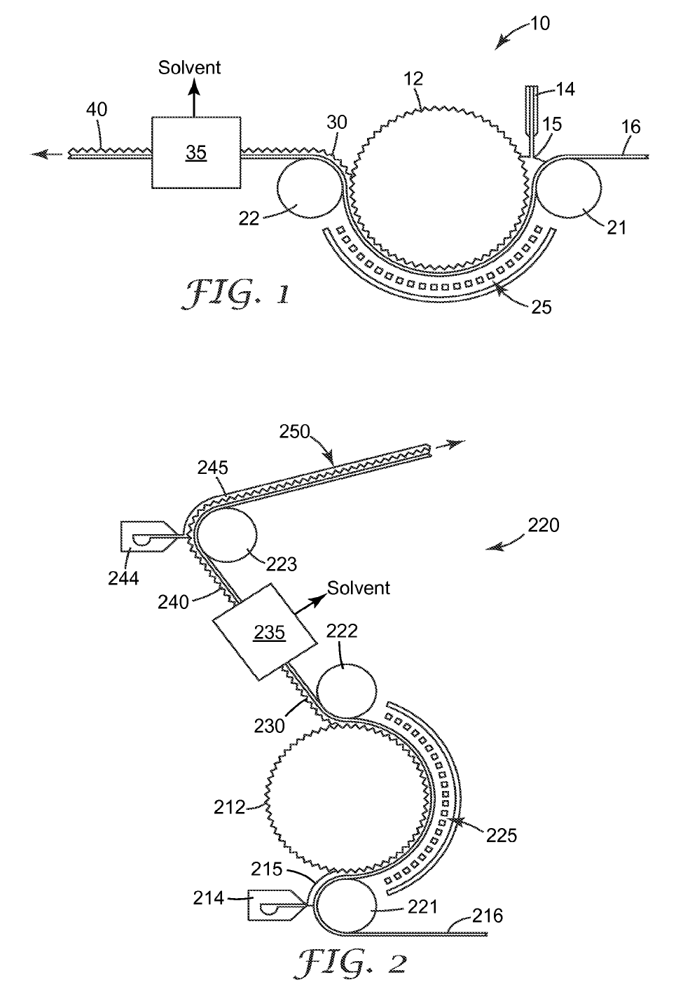

FIG. 1 is a schematic diagram of an illustrative process 110 of forming a nanovoided microstructured article 140, and a corresponding system for manufacturing such articles. The process 110 includes disposing a coating solution 115 onto a substrate 116. In some embodiments the coating solution 115 is applied using a die 114 such as a needle die for example. The coating solution 115 includes a polymerizable material and a solvent. Then the process 110 includes polymerizing the polymerizable material while the coating solution 115 is in contact with a microreplication tool 112 to form a microstructured layer 130. Solvent is then removed, for example by an oven 135, from the microstructured layer 130 to form the nanovoided microstructured article 140. In alternate embodiments, the coating solution 115 may be is disposed on the microreplication tool 112 and then a substrate 116 may contact the microreplication tool 112. The coating solution 115 can be cured before or after the substrate 116 contacts the microreplication tool 112. In any of the polymerization or curing steps, a controlled environment can include inerting gases such as nitrogen to control oxygen content, solvent vapors to reduce the loss of solvent, or a combination of inert gases and solvent vapors. The oxygen concentration can affect both the rate and extent of polymerization, some instances the oxygen concentration in the controlled environment is reduced to less than 1000 parts-per-million (ppm), less than 500 ppm, less than 300 ppm, less than 150 ppm, less than 100 ppm, or even less than 50 ppm.

The microstructured layer 130 includes an amount of solvent that is at least partially removed from the microstructured layer 130 by any useful method, such as heating in an oven 135, as illustrated, for example. The solvent laden microstructured layer 130 can include at least 10% solvent, or at least 30%, 50%, 60%, or 70% solvent (all on a weight %). In some embodiments the microstructured layer 130 includes from 30% to 70% solvent or from 35 to 60% solvent (by weight). The amount of solvent in the original coating can correspond to the void volume formed in the nanovoided microstructured article 140, particularly where substantially all of the solvent that was present in the original coating escapes from the layer during processing so as to leave behind a plurality or network of interconnecting voids.

The microreplication tool 112 can he any useful microreplication tool. The microreplication tool 112 is illustrated as a roll where the microreplication surface is on the exterior of the roll. It is also contemplated that the microreplication apparatus can include a smooth roll where the microreplication tool is a structured surface of the substrate 116 that contacts the coating solution 115. The illustrated microreplication tool 112 includes a nip roll 121 and a take-away roll 122.

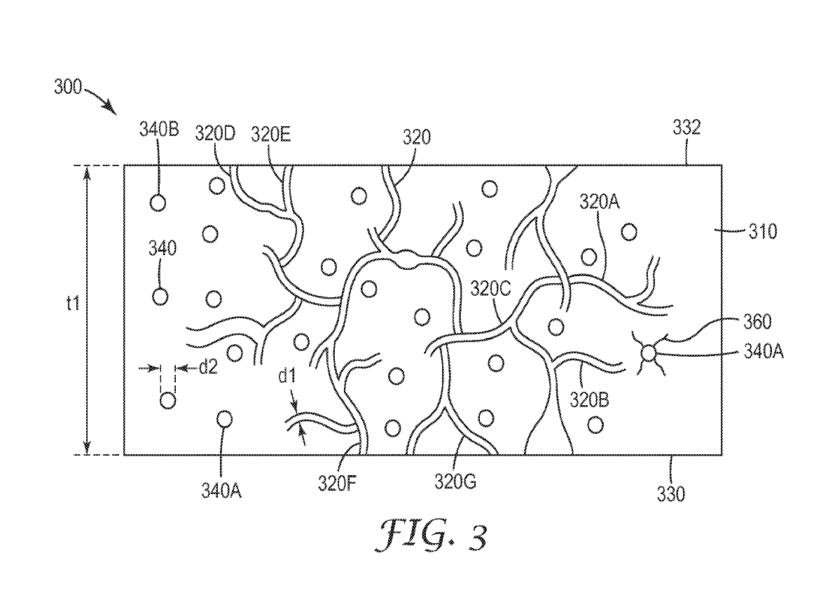

A curing source 125 such as a bank of UV lights is illustrated as being directed toward the substrate 116 and coating solution 115 while the coating solution 115 is in contact with microreplication tool 112 to form microstructured layer 130. In some embodiments, the substrate 116 can transmit the curing light to the coating solution 115 to cure the coating solution 115 and form the microstructured layer 130. In other embodiments the curing source 125 is a heat source and the coating solution 115 includes a thermal curing material. The curing source 125 can be disposed either as illustrated or within the microreplication tool 112. When the curing source 125 is disposed within the microreplication tool 112 the microreplication tool 112 can transmit light through the microreplication tool 112 (the microreplication tool 112 can be made of a material that is transmissive to the curing light such as quartz, for example) to the coating solution 115 to cure the coating solution 115 and form the microstructured layer 130. FIG. 2 is a schematic diagram of an illustrative process 220 of forming a backfilled nanovoided microstructured article 250, and a corresponding system for manufacturing such articles. The process 220 includes disposing a coating solution 215 onto a substrate 216. In some cases the coating solution 215 may be applied using a die 214 such as a slot coater die for example. The coating solution 215 includes a polymerizable material and a solvent. Then the process 220 includes polymerizing the polymerizable material while the coating solution 215 is in contact with a microreplication tool 212 to form a microstructured layer 230. Solvent is then removed, for example by an oven 235, from the microstructured layer 230 to form the nanovoided microstructured article 240. Then the process 220 includes disposing a polymeric material 245 on the nanovoided microstructured article 240 to form a backfilled nanovoided microstructured article 250. The polymeric material 245 may be applied using a die 244 such as a slot coater die for example, or by other suitable means. The polymeric material 245 may alternatively be laminated onto the nanovoided microstructured article 240 to form the nanovoided microstructured article 250. The microreplication tool 212 can be any useful microreplication tool, as described above. The illustrated microreplication tool 212 includes a nip roll 221 and a take-away roll 222. A curing source 225, such as UV lights are illustrated as being directed toward the substrate 216 and coating solution 215 while the coating solution 215 is in contact with a microreplication tool 212 to form a microstructured layer 230. In some embodiments, the substrate 216 can transmit the curing light to the coating solution 215 to cure the coating solution 215 and form the microstructured layer 230. In other embodiments the curing source 225 is a heat source and the coating solution 215 includes a thermal curing material. The curing source 225 can be disposed either as illustrated or within the microreplication tool 212. When the curing source 225 is disposed within the microreplication tool 212 the microreplication tool 212 can transmit light to the coating solution 215 to cure the coating solution 215 and form the microstructured layer 230. The processes to form the nanovoided microstructured articles described herein can include additional processing steps such as post-cure or further polymerization steps, for example. In some cases, a post-cure step is applied to the nanovoided microstructured article following the solvent removal step. In some embodiments, these processes can include additional processing equipment common to the production of web-based materials, including, for example, idler rolls; tensioning rolls; steering mechanisms;

surface treaters such as corona or flame treaters; lamination rolls; and the like. In some cases, these processes can utilize different web paths, coating techniques, polymerization apparatus, positioning of polymerization apparatus, drying ovens, conditioning sections, and the like, and some of the sections described can be optional. In some cases, one, some, or all steps of the process can be carried out as a “roll-to-roll” process wherein at least one roll of substrate is passed through a substantially continuous process and ends up on another roll or is converted via sheeting, laminating, slitting, or the like.

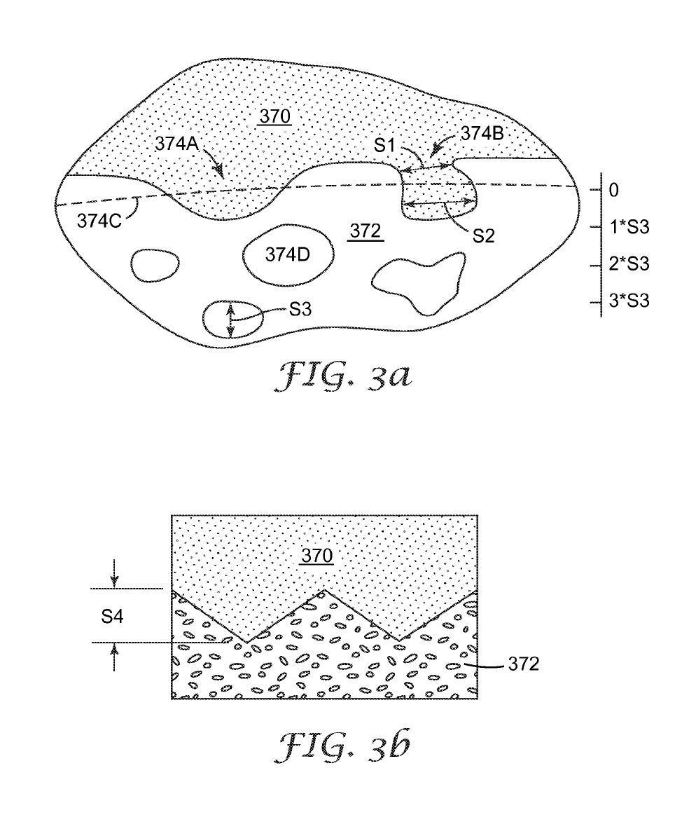

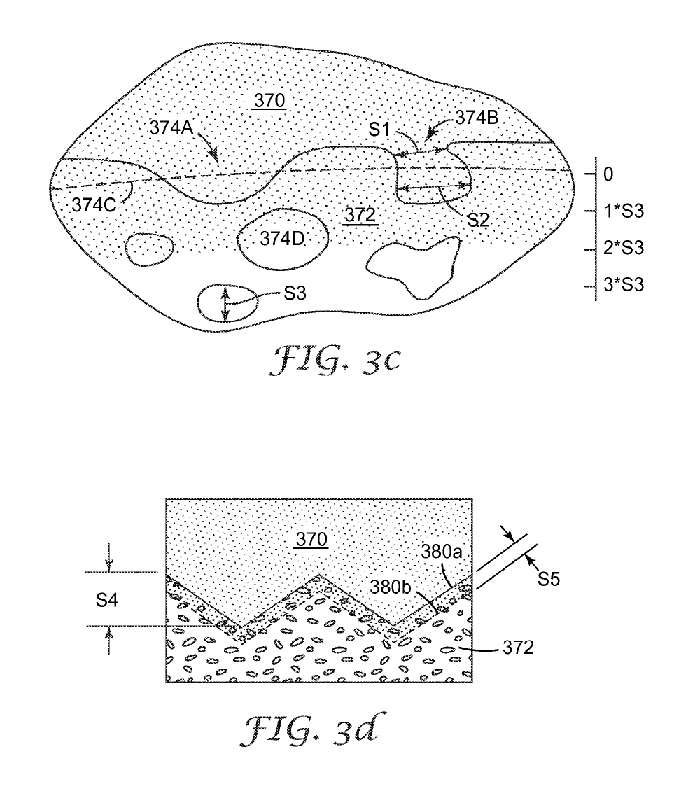

FIG. 3 is a schematic side elevational view of a portion of a nanovoided microstructured layer 300. Although the nanovoided microstructured layer 300 is illustrated having two planar outer surfaces, it is understood that at least one of the outer surfaces is microstructured.

Exemplary nanovoided microstructured layers 300 include a plurality of interconnected voids or a network of voids 320 dispersed in a hinder 310. At least some of the voids in the plurality or network are connected to one another via hollow tunnels or hollow tunnel-like passages. The interconnected voids may be the remnant of an interconnected mass of solvent that formed part of the originally coated film, and that was driven out of the film by the oven or other means after curing of the polymerizable material. The network of voids 320 can be regarded to include interconnected voids or pores 320A-320C as shown in FIG. 3. The voids arc not necessarily free of all matter and/or particulates. For example, in some cases, a void may include one or more small fiber- or string-like objects that include, for example, a binder and/or nanoparticles. Some disclosed nanovoided microstructured layers include multiple sets of interconnected voids or multiple networks of voids where the voids in each set or network are interconnected. In some cases, in addition to multiple pluralities or sets of interconnected voids, the nanovoided microstructured layer may also include a plurality of closed or unconnected voids, meaning that the voids are not connected to other voids via tunnels. In cases where a network of voids 320 forms one or more passages that extend from a first major surface 330 to an opposed second major surface 332 of the nanovoided layer 300, the layer 300 may be described as being a porous layer.

Some of the voids can reside at or interrupt a surface of the nanovoided microstructured layer and can be considered to be surface voids. For example, in the exemplary nanovoided microstructured layer 300, voids 320D and 320E reside at second major surface 332 of the nanovoided microstructured layer and can be regarded as surface voids 320D and 320E, and voids 320F and 320G reside at first major surface 330 of the nanovoided microstructured layer and can be regarded as surface voids 320F and 320G. Somc of the voids, such as voids 320B and 320C, arc disposed within the interior of the optical film and away from the exterior surfaces of the optical film, and can thus be regarded as interior voids 320B and 320C even though an interior void may be connected to a major surface via one or more other voids.

Voids 320 have a size dl that can generally be controlled by choosing suitable composition and fabrication, such as coating, drying and curing conditions. In general, dl can be any desired value in any desired range of values. For example, in some cases, at least a majority of the voids, such as at least 60% or 70% or 80% or 90% or 95% of the voids, have a size that is in a desired range. For example, in some cases, at least a majority of the voids, such as at least 60% or 70% or 80% or 90% or 95% of the voids, have a size that is not greater than about 10 micrometers, or not greater than about 7, or 5, or 4, or 3, or 2, or 1, or 0.7, or 0.5 micrometers.

In some cases, a plurality of interconnected voids 320 has an average void or pore size that is not greater than about 5 micrometers, or not greater than about 4 micrometers, or not greater than about 3 micrometers, or not greater than about 2 micrometers, or not greater than about 1 micrometer, or not greater than about 0.7 micrometers, or not greater than about 0.5 micrometers.

In some cases, some of the voids can be sufficiently small so that their primary optical effect is to reduce the effective index, while some other voids can reduce the effective index and scatter light, while still some other voids can be sufficiently large so that their primary optical effect is to scatter light.

The nanovoided microstructured layer 300 may have any useful thickness t1 (linear distance between a first major surface 330 and second major surface 332). In many embodiments the nanovoided microstructured layer may have a thickness t1 that is not less than about 100 nm, or not less than about 500 nm, or not less than about 1,000 nm, or in a range from 0.1 to 10 micrometers, or in a range from 1 to 100 micrometers.

In some cases, the nanovoided microstructured layer may be thick enough so that the nanovoided microstructured layer can reasonably have an effective refractive index that can be expressed in terms of the indices of refraction of the voids and the binder, and the void or pore volume fraction or porosity. In such cases, the thickness of the nanovoided microstructured layer is not less than about 500 nm, or not less than about 1,000 nm, or in a range from 1 to 10 micrometers, or in a range from 500 nm to 100 micrometers, for example. When the voids in a disclosed nanovoided microstructured layer are sufficiently small and the nanovoided microstructured layer is sufficiently thick, the nanovoided microstructured layer has an effective permittivity E_{eff} that can be expressed as:

ε_{eff}=(f)εᵥ+(1−f)ε_{b}, (1)

where εᵥ and ε_{b} are the permitivities of the voids and the binder respectively, and f is the volume fraction of the voids in the nanovoided microstructured layer. In such cases, the effective refractive index n_{eff} of the nanovoided microstructured layer can be expressed as:

n_{eff}² =(f)nᵥ²+(1−f)n_{b}², (2)

where nᵥ and n_{b} are the refractive indices of the voids and the binder respectively. In some cases, such as when the difference between the indices of refraction of the voids and the binder is sufficiently small, the effective index of the nanovoided microstructured layer can be approximated by the following expression:

n_{eff}≈(f)nᵥ+(1−f)n_{b}, (3)

In such cases, the effective index of the nanovoided microstructured layer is the volume weighted average of the indices of refraction of the voids and the binder. For example, a nanovoided microstructured layer that has a void volume fraction of 50% and a binder that has an index of refraction of 1.5 has an effective index of about 1.25 as calculated by equation (3), and an effective index of about 1.27 as calculated by the more precise equation (2). In some exemplary embodiments the nanovoided microstructured layer may have an effective refractive index in a range from 1.15 to 1.45, or 1.15 to 1.4, or 1.15 to 1.35, or 1.15 to 1.3. In some embodiments the nanovoided microstructured layer may have an effective refractive index in a range from 1.2 to 1.4. In some cases it may be desirable to increase the effective refractive index, e.g., to a value in the range from 1.4 to 2.0, by incorporating high refractive index nanoparticles such as zirconia (n=2.2) and titania (n=2.7).

The nanovoided layer 300 of FIG. 3 is also shown to include, in addition to the plurality of interconnected voids or network of voids 320 dispersed in the binder 310, an optional plurality of nanoparticles 340 dispersed substantially uniformly within the binder 310.

Nanoparticics 340 have a size d2 that can be any desired value in any desired range of values. For example, in some cases at least a majority of the particles, such as at least 60% or 70% or 80% or 90% or 95% of the particles, have a size that is in a desired range.

For example, in some cases, at least a majority of the particles, such as at least 60% or 70% or 80% or 90% or 95% of the particles, have a size that is not greater than about 1 micrometer, or not greater than about 700, or 500, or 200, or 100, or 50 nanometers. In some cases, the plurality of nanoparticles 340 may have an average particle size that is not greater than about 1 micrometer, or not greater than about 700, or 500, or 200, or 100, or 50 nanometers.

In some cases, some of the nanoparticles can he sufficiently small so that they primarily affect the effective index, while some other nanoparticles can affect the effective index and scatter light, while still some other particles can be sufficiently large so that their primary optical effect is to scatter light.

The nanoparticles 340 may or may not be functionalized. In some cases, some, most, or substantially all of the nanoparticles 340, such as nanoparticle 340B, are not functionalized. In some cases, some, most, or substantially all of the nanoparticles 340 are functionalized or surface treated so that they can be dispersed in a desired solvent or binder 310 with no, or very little, clumping. In some embodiments, nanoparticles 340 can be further functionalized to chemically bond to binder 310. For example, nanoparticles such as nanoparticle 340A, can be surface modified or surface treated to have reactive functionalities or groups 360 to chemically bond to binder 310. Nanoparticles can be functionalized with multiple chemistries, as desired. In such cases, at least a significant fraction of nanoparticles 340A are chemically bound to the binder. In some cases, nanoparticles 340 do not have reactive functionalities to chemically bond to binder 310. In such cases, nanoparticles 340 can be physically bound to binder 310.

In some cases, some of the nanoparticles have reactive groups and others do not have reactive groups. An ensemble of nanoparticles can include a mixture of sizes, reactive and nonreactive particles, and different types of particles (e.g., silica and zirconium oxide). In some cases, the nanoparticles may include surface treated silica nanoparticles.

The nanoparticles may be inorganic nanoparticles, organic (e.g., polymeric) nanoparticles, or a combination of organic and inorganic nanoparticles. Furthermore, the nanoparticles may be porous particles, hollow particles, solid particles, or combinations thereof. Examples of suitable inorganic nanoparticles include silica and metal oxide nanoparticles including zirconia, titania, ceria, alumina, iron oxide, vanadia, antimony oxide, tin oxide, alumina/silica, and combinations thereof. The nanoparticles can have an average particle diameter less than about 1000 nm, or less than about 100 or 50 nm, or the average may be in a range from about 3 to 50 nm, or from about 3 to 35 nm, or from about 5 to 25 nm. If the nanoparticles are aggregated, the maximum cross sectional dimension of the aggregated particle can be within any of these ranges, and can also be greater than about 100 nm. In some embodiments, “fumed” nanoparticles, such as silica and alumina, with primary size less than about 50 nm, are also included, such as CAB-O-SPERSE® PG 002 fumed silica, CAB-O-SPERSE® 2017A fumed silica, and CAB-O-SPERSE® PG 003 fumed alumina, available from Cabot Co. Boston, Mass.

The nanoparticles may include surface groups selected from the group consisting of hydrophobic groups, hydrophilic groups, and combinations thereof. Alternatively, the nanoparticles may include surface groups derived from an agent selected from the group consisting of a silane, organic acid, organic base, and combinations thereof. In other embodiments, the nanoparticles include organosilyl surface groups derived from an agent selected from the group consisting of alkylsilane, arylsilane, alkoxysilane, and combinations thereof.

The term “surface-modified nanoparticle” refers to a particle that includes surface groups attached to the surface of the particle. The surface groups modify the character of the particle. The terms “particle diameter” and “particle size” refer to the maximum cross-sectional dimension of a particle. If the particle is present in the form of an aggregate, the terms “particle diameter” and “particle size” refer to the maximum cross-sectional dimension of the aggregate. In some cases, particles can be large aspect ratio aggregates of nanoparticles, such as fumed silica particles.

The surface-modified nanoparticles have surface groups that modify the solubility characteristics of the nanoparticles. The surface groups are generally selected to render the particle compatible with the coating solution. In one embodiment, the surface groups can be selected to associate or react with at least one component of the coating solution, to become a chemically bound part of the polymerized network.

A variety of methods are available for modifying the surface of nanoparticles including, e.g., adding a surface modifying agent to nanoparticles (e.g., in the form of a powder or a colloidal dispersion) and allowing the surface modifying agent to react with the nanoparticles. Other useful surface modification processes are described in, e.g., U.S. Pat. Nos. 2,801,185 (Iler) and 4,522,958 (Das et al.).

Useful surface-modified silica nanoparticles include silica nanoparticles surface-modified with silane surface modifying agents including, e.g., Silquest® silanes such as Silquest® A-1230 from GE Silicones, 3-acryloyloxypropyl trimethoxysilane, 3-methacryloyloxypropyltrimethoxysilane, 3-mercaptopropyltrimethoxysilane, noctyltrimethoxysilane, isooctyltrimethoxysilane, 4-(triethoxysilyl)-butyronitrile, (2-cyanoethyl)triethoxysilane, N-(3-triethoxysilylpropyl) methoxyethoxyethoxyethyl carbamate (PEG3TMS), N-(3-triethoxysilylpropyl) methoxyethoxyethoxyethyl carbamate (PEG2TMS), 3-(methacryloyloxy) propyltriethoxysilane, 3-(methacryloyloxy) propylmethyldimethoxysilane, 3-(acryloyloxypropyl) methyldimethoxysilane, 3-(methacryloyloxy) propyldimethylethoxysilane, 3-(methacryloyloxy) propyldimethylethoxysi lane, vinyldimethylethoxysi lane, phenyltrimethoxysilane, noctyltrimethoxysilane, dodecyltrimethoxysilane, octadecyltrimethoxysilane, propyltrimethoxysilanc, hcxyltrimcthoxysilanc, vinylmethyldiacctoxysilanc, vinylmethyldiethoxysilane, vinyltriacetoxysilane, vinyltriethoxysilane, vinyltriisopropoxysilane, vinyltrimethoxysilane, vinyltriphenoxysilane, vinyltritbutoxysilane, vinyltris-isobutoxysilane, vinyltriisopropenoxysilane, vinyltris(2-methoxyethoxy)silane, and combinations thereof. Silica nanoparticles can be treated with a number of surface modifying agents including, e.g., alcohol, organosilane including, e.g., alkyltrichlorosilanes, trialkoxyarylsilanes, trialkoxy(alkyl)silanes, and combinations thereof and organotitanates and mixtures thereof.

The nanoparticles may be provided in the form of a colloidal dispersion. Examples of useful commercially available unmodified silica starting materials include nano-sized colloidal silicas available under the product designations NALCO 1040, 1050, 1060, 2326, 2327, and 2329 colloidal silica from Nalco Chemical Co., Naperville, Ill.; the organosilica under the product name IPA-ST-MS, IPA-ST-L, IPA-ST, IPA-ST-UP, MA-ST-M, and MA-ST sols from Nissan Chemical America Co. Houston, Tex. and the SnowTex® ST-40, ST-50, ST-20L, ST-C, ST-N, ST-O, ST-OL, ST-ZL, ST-UP, and ST-OUP, also from Nissan Chemical America Co. Houston, TX. The weight ratio of polymerizable material to nanoparticles can range from about 30:70, 40:60, 50:50, 55:45, 60:40, 70:30, 80:20 or 90:10 or more. The preferred ranges of wt % of nanoparticles range from about 10% by weight to about 60% by weight, and can depend on the density and size of the nanoparticle used.

In some cases, the nanovoided microstructured layer 300 may have a low optical haze value. In such cases, the optical haze of the nanovoided microstructured layer may be no more than about 5%, or no greater than about 4, 3.5, 3, 2.5, 2, 1.5, or 1%. For light normally incident on nanovoided microstructured layer 300, “optical haze” may (unless otherwise indicated) refer to the ratio of the transmitted light that deviates from the normal direction by more than 4 degrees to the total transmitted light. Measured index of refraction values that are reported herein were, unless otherwise indicated, measured using a Metricon Model 2010 Prism Coupler, available from Metricon Corp., Pennington, N.J. Measured optical transmittance, clarity, and haze values reported herein were, unless otherwise indicated, measured using a Haze-Gard Plus haze meter, available from BYKGardiner, Silver Springs, Md..

In some cases, the nanovoided microstructured layer 300 may have a high optical haze. In such cases, the haze of the nanovoidcd microstructured layer 300 is at least about 40%, or at least about 50, 60, 70, 80, 90, or 95%.

In general, the nanovoided microstructured layer 300 can have any porosity or void volume fraction that may be desirable in an application. In some cases, the volume fraction of plurality of voids 320 in nanovoided microstructured layer 300 is at least about 10%, or at least about 20, 30, 40, 50, 60, 70, 80, or 90%.

Binder 310 can be or include any material that may be desirable in an application. For example, binder 310 can be a light curable material that forms a polymer, such as a crosslinked polymer. In general, binder 310 can be any polymerizable material, such as a polymerizable material that is radiation-curable. In some embodiments binder 310 can be any polymerizable material, such as a polymerizable material that is thermally-curable.

Polymerizable material 310 can be any polymerizable material that can be polymerized by various conventional anionic, cationic, free radical or other polymerization technique, which can be chemically, thermally, or initiated with actinic radiation, e.g., processes using actinic radiation including, e.g., visible and ultraviolet light, electron beam radiation and combinations thereof, among other means. The media that polymerizations can be carried out in include, including, e.g., solvent polymerization, emulsion polymerization, suspension polymerization, bulk polymerization, and the like. Actinic radiation curable materials include monomers, and reactive oligomers, and polymers of acrylates, methacrylates, urethanes, epoxies, and the like. Representative examples of actinic radiation curable groups suitable in the practice of the present disclosure include epoxy groups, ethylenically unsaturated groups such as (meth)acrylate groups, olefinic carboncarbon double bonds, allyloxy groups, alpha-methyl styrene groups, (meth)acrylamide groups, cyanoester groups, vinyl ethers groups, combinations of these, and the like. Free radically polymerizable groups are preferred. In some embodiments, exemplary materials include acrylate and methacrylate functional monomers, oligomers, and polymers, and in particular, multifunctional monomers that can form a crosslinked network upon polymerization can be used, as known in the art. The polymerizable materials can include any mixture of monomers, oligomers, and polymers; however the materials should be at least partially soluble in at least one solvent. In some embodiments, the materials should be soluble in the solvent monomer mixture.

As used herein, the term “monomer” means a relatively low molecular weight material (i.e., having a molecular weight less than about 500 g/mole) having one or more polymerizable groups. “Oligomer” means a relatively intermediate molecular weight material having a molecular weight of from about 500 up to about 10,000 g/mole. “Polymer” means a relatively high molecular weight material having a molecular weight of at least about 10,000 g/mole, preferably at 10,000 to 100,000 g/mole. The term “molecular weight” as used throughout this specification means number average molecular weight, unless expressly noted otherwise.

Exemplary monomeric polymerizable materials include styrene, alpha-methylstyrene, substituted styrene, vinyl esters, vinyl ethers, N-vinyl-2-pyrrolidone, (meth)acrylamide, Nsubstituted (meth)acrylamide, octyl (meth)acrylate, iso-octyl (meth)acrylate, nonylphenol ethoxylate (meth) acrylate, isononyl (meth)acrylate, diethylene glycol (meth)acrylate, isobornyl (meth)acrylate, 2-(2-ethoxyethoxy)ethyl (meth)acrylate, 2-ethylhexyl (meth)acrylate, lauryl (meth)acrylate, butanediol mono(meth) acrylate, beta-carboxyethyl (meth)acrylate, isobutyl (meth)acrylate, cycloaliphatic epoxide, alpha-epoxide, 2-hydroxyethyl (meth)acrylate, (meth)acrylonitrile, maleic anhydride, itaconic acid, isodecyl (meth) acrylate, dodecyl (meth)acrylate, n-butyl (meth)acrylate, methyl (meth) acrylate, hexyl (meth)acrylate, (meth)acrylic acid, N-vinylcaprolactam, stcaryl (meth)acrylate, hydroxyl functional polycaprolactone ester (meth) acrylate, hydroxyethyl (meth)acrylate, hydroxymethyl (meth)acrylate, hydroxypropyl (meth)acrylate, hydroxy isopropyl (meth)acry late, hydroxybutyl (meth)acrylate, hydroxyisobutyl (meth)acrylate, tetrahydrofurfuryl (meth)acrylate, combinations of these, and the like.

Functional oligomers and polymers may also be collectively referred to herein as “higher molecular weight constituents or species.” Suitable higher molecular weight constituents may be incorporated into compositions of the present disclosure. Such higher molecular weight constituents may provide benefits including viscosity control, reduced shrinkage upon curing, durability, flexibility, adhesion to porous and nonporous substrates, outdoor weatherability, and/or the like. The amount of oligomers and/or polymers incorporated into fluid compositions of the present disclosure may vary within a wide range depending upon such factors as the intended use of the resultant composition, the nature of the reactive diluent, the nature and weight average molecular weight of the oligomers and/or polymers, and the like. The oligomers and/or polymers themselves may be straight-chained, branched, and/or cyclic. Branched oligomers and/or polymers tend to have lower viscosity than straight-chain counterparts of comparable molecular weight.

Exemplary polymerizable oligomers or polymers include aliphatic polyurethanes, acrylics, polyesters, polyimides, polyamides, epoxy polymers, polystyrene (including copolymers of styrene) and substituted styrenes, silicone containing polymers, fluorinated polymers, combinations of these, and the like. For some applications, polyurethane and acrylate oligomers and/or polymers can have improved durability and weatherability characteristics. Such materials also tend to be readily soluble in reactive diluents formed from radiation curable, (meth)acrylate functional monomers.

Because aromatic constituents of oligomers and/or polymers generally tend to have poor weatherability and/or poor resistance to sunlight, aromatic constituents can be limited to less than 5 weight percent, preferably less than 1 weight percent, and can be substantially excluded from the oligomers and/or polymers and the reactive diluents of the present disclosure. Accordingly, straight-chained, branched and/or cyclic aliphatic and/or heterocyclic ingredients are preferred for forming oligomers and/or polymers to be used in outdoor applications.

Suitable radiation curable oligomers and/or polymers for use in the present disclosure include, but arc not limited to, (meth)acrylated urethanes (i.e., urethane (meth)acrylates), (meth)acrylated epoxies (i.e., epoxy (meth)acrylates), (meth)acrylated polyesters (i.e., polyester (meth)acrylates), (meth)acrylated (meth)acrylics, (meth)acrylated silicones, (meth)acrylated polyethers (i.e., polyether (meth)acrylates), vinyl (meth)acrylates, and (meth)acrylated oils.

Materials useful for toughening the nanovoided layer 300 include resins with high tensile strength and high elongation, for example, CN9893, CN902, CN9001, CN961, and CN964 that are commercially available from Sartomer Company; and Ebecryl 4833 and Eb8804 that are commercially available Cytec. Suitable toughening materials also include combinations of “hard” oligomeric acrylates and “soft” oligomeric acrylates. Examples of “hard” acrylates include polyurethane acrylates such as Ebecryl 4866, polyester acrylates such as Ebecryl 838, and epoxy acrylates such as Ebecryl 600, Ebecryl 3200, and Ebecryl 1608 (commercially available from Cytec); and CN2920, CN2261, and CN9013 (commercially available from Sartomer Company). Examples of the “soft” acrylates include Ebecryl 8411 that is commercially available from Cytec; and CN959, CN9782, and CN973 that arc commercially available from Sartomer Company. These materials are effective at toughening the nanovoided structured layer when added to the coating formulation in the range of 5-25% by weight of total solids (excluding the solvent fraction).

Solvent can be any solvent that forms a solution with the desired polymerizable material. The solvent can be a polar or a non-polar solvent, a high boiling point solvent or a low boiling point solvent, and in some embodiments the solvent includes a mixture of several solvents. The solvent or solvent mixture may be selected so that the microstructured layer 130, 230 formed is at least partially insoluble in the solvent (or at least one of the solvents in a solvent mixture). In some embodiments, the solvent mixture can be a mixture of a solvent and a non-solvent for the polymerizable material. In one particular embodiment, the insoluble polymer matrix can be a three-dimensional polymer matrix having polymer chain linkages that provide the three dimensional framework. The polymer chain linkages can prevent deformation of the microstructured layer 30 after removal of the solvent.

In some cases, solvent can be easily removed from the solvent-laden microstructured layer 130, 230 by drying, for example, at temperatures not exceeding the decomposition temperature of either the insoluble polymer matrix, or the substrate 116, 216. In one particular embodiment, the temperature during drying is kept below a temperature at which the substrate is prone to deformation, e.g., a warping temperature or a glass-transition temperature of the substrate. Exemplary solvents include linear, branched, and cyclic hydrocarbons, alcohols, ketones, and ethers, including for example, propylene glycol ethers such as DOWANOL™ PM propylene glycol methyl ether, isopropyl alcohol, ethanol, toluene, ethyl acetate, 2-butanone, butyl acetate, methyl isobutyl ketone, methyl ethyl ketone, cyclohexanone, acetone, aromatic hydrocarbons, isophorone, butyrolactone, N-methylpyrrolidone, tetrahydrofuran, esters such as lactates, acetates, propylene glycol monomethyl ether acetate (PM acetate), diethylene glycol ethyl ether acetate (DE acetate), ethylene glycol butyl ether acetate (EB acetate), dipropylene glycol monomethyl acetate (DPM acetate), iso-alkyl esters, isohcxyl acetate, isoheptyl acetate, isooctyl acetate, isononyl acetate, isodecyl acetate, isododecyl acetate, isotridecyl acetate or other iso-alkyl esters, water; combinations of these and the like.

The coating solution 115, 215 can also include other ingredients including, e.g., initiators, curing agents, cure accelerators, catalysts, crosslinking agents, tackificrs, plasticizers, dyes, surfactants, flame retardants, coupling agents, pigments, impact modifiers including thermoplastic or thermoset polymers, flow control agents, foaming agents, fillers, glass and polymer microspheres and microparticles, other particles including electrically conductive particles, thermally conductive particles, fibers, antistatic agents, antioxidants, optical down converters such as phosphors, UV absorbers, and the like.

An initiator, such as a photoinitiator, can be used in an amount effective to facilitate polymerization of the monomers present in the coating solution. The amount of photoinitiator can vary depending upon, for example, the type of initiator, the molecular weight of the initiator, the intended application of the resulting microstructured layer, and the polymerization process including, e.g., the temperature of the process and the wavelength of the actinic radiation used. Useful photoinitiators include, for example, those available from Ciba Specialty Chemicals under the IRGACURE™ and DAROCURE™ trade designations, including IRGACURE™ 184 and IRGACURE™ 819.

In some embodiments, a mixture of initiators and initiator types can be used, for example to control the polymerization in different sections of the process. In one embodiment, optional post-processing polymerization may be a thermally initiated polymerization that requires a thermally generated free-radical initiator. In other embodiments, optional post-processing polymerization may be an actinic radiation initiated polymerization that requires a photoinitiator. The post-processing photoinitiator may be the same or different than the photoinitiator used to polymerize the polymer matrix in solution.

The microstructured layer 130, 230 may be cross-linked to provide a more rigid polymer network. Cross-linking can be achieved with or without a cross-linking agent by using high energy radiation such as gamma or electron beam radiation. In some embodiments, a cross-linking agent or a combination of cross-linking agents can be added to the mixture of polymerizable monomers, oligomers or polymers. The cross-linking can occur during polymerization of the polymer network using any of the actinic radiation sources described elsewhere.

Useful radiation curing cross-linking agents include multifunctional acrylates and methacrylates, such as those disclosed in U.S. Pat. No. 4,379,201 (Hcilmann et al.), which include 1,6-hexanediol di(meth)acrylate, trimethylolpropane tri(meth)acrylate, 1,2-ethylene glycol di(meth)acrylate, pentaerythritol tri/tetra(meth)acrylate, triethylene glycol di(meth) acrylate, ethoxylated trimethylolpropane tri(meth)acrylate, glycerol tri(meth)acrylate, neopentyl glycol di(meth) acrylate, tetraethylene glycol di(meth)acrylate, 1,12-dodecanol di (meth)acrylate, copolymerizable aromatic ketone co-monomers such as those disclosed in U.S. Pat. No. 4,737,559 (Kellen et al.) and the like, and combinations thereof.

The coating solution 115, 215 may also include a chain transfer agent. The chain transfer agent is preferably soluble in the monomer mixture prior to polymerization. Examples of suitable chain transfer agents include triethyl silane and mercaptans. In some embodiments, chain transfer can also occur to the solvent; however this may not be a preferred mechanism.

The polymerizing step preferably includes using a radiation source in an atmosphere that has a low oxygen concentration. Oxygen is known to quench free-radical polymerization, resulting in diminished extent of cure. The radiation source used for achieving polymerization and/or crosslinking may be actinic (e.g., radiation having a wavelength in the ultraviolet or visible region of the spectrum), accelerated particles (e.g., electron beam radiation), thermal (e.g., heat or infrared radiation), or the like. In some embodiments, the energy is actinic radiation or accelerated particles, because such energy provides excellent control over the initiation and rate of polymerization and/or crosslinking. Additionally, actinic radiation and accelerated particles can be used for curing at relatively low temperatures. This avoids degrading or evaporating components that might be sensitive to the relatively high temperatures that might be required to initiate polymerization and/or crosslinking of the energy curable groups when using thermal curing techniques. Suitable sources of curing energy include UV LEDs, visible LEDs, lasers, electron beams, mercury lamps, xenon lamps, carbon arc lamps, tungsten filament lamps, flashlamps, sunlight, low intensity ultraviolet light (black light), and the like.

In some embodiments, binder 310 includes a multifunctional acrylate and polyurethane. This binder 310 can be a polymerization product of a photoinitiator, a multifunctional acrylate, and a polyurethane oligomer. The combination of a multifunctional acrylate and a polyurethane oligomer can produce a more durable nanovoided microstructurcd layer 300. The polyurethane oligomer is ethylcnically unsaturated. In some embodments, the polyurethane or polyurethane oligomer is capable of reacting with acrylates or “capped” with an acrylate to be capable of reacting with other acrylates in the polymerization reaction described herein.

In one illustrative process described above in FIG. 1, a solution is prepared that includes a plurality of nanoparticles (optional), and a polymerizable material dissolved in a solvent, where the polymerizable material can include, for example, one or more types of monomers. The polymerizable material is coated onto a substrate and a tool is applied to the coating while the polymerizable material is polymerized, for example by applying heat or light, to form an insoluble polymer matrix in the solvent. In some cases, after the polymerization step, the solvent may still include some of the polymerizable material, although at a lower concentration. Next, the solvent is removed by drying or evaporating the solution resulting in nanovoided microstructured layer 300 that includes a network or plurality of voids 320 dispersed in polymer binder 310. The nanovoided microstructured layer 300 includes a plurality of nanoparticles 340 dispersed in the polymer binder. The nanoparticles are bound to the binder, where the bonding can be physical or chemical.

The fabrication of the nanovoided microstructured layer 300 and microstructured articles described herein using the processes described herein can be performed in a temperature range that is compatible with the use of organic substances, resins, films and supports. In many embodiments, the peak process temperatures (as determined by an optical thermometer aimed at the nanovoided microstructured layer 300 and microstructured article surface) is 200 degrees centigrade or less, or 150 degrees centigrade or less or 100 degrees centigrade or less. In general, nanovoided microstructured layer 300 can have a desirable porosity for any weight ratio of binder 310 to plurality of nanoparticles 340. Accordingly, in general, the weight ratio can be any value that may be desirable in an application. In some cases, the weight ratio of hinder 310 to a plurality of nanoparticles 340 is at least about 1:2.5, or at least about 1:2.3, or 1:2, or 1:1, or 1.5:1, or 2:1, or 2.5:1, or 3:1, or 3.5:1, or 4:1, or 5:1. In some cases, the weight ratio is in a range from about 1:2.3 to about 4:1.

We now pause to consider, in connection with FIGS. 3a-d, whether there is any structural difference between (a) an article made by first forming a nanovoided layer with a microstructured surface, and then backfilling that microstructured surface with a conventional (non-nanovoided) material, e.g. a conventional polymer material, and (b) an article made by first forming a microstructured surface in a layer of conventional material, and then backfilling that microstructured surface with a nanovoided material layer. In both cases, the resulting article has an embedded interface, i.e., the microstructured surface, on one side of which is the nanovoided material layer and on the other side of which is the conventional material layer.

We have found that at least one structural difference can occur between the two articles, and that structural difference relates to the mechanism of interpenetration. In the article of case (b), where the layer of conventional material is microstructured before backfilling the microstructured surface with the nanovoided material, the nanovoided material would not typically migrate into the layer of conventional material because that layer typically presents a substantially solid, non-porous barrier at each facet or portion of the microstructured surface beyond which the nanovoided material cannot penetrate. In contrast, the article of case (a) is made in such a way that, at the time the conventional material (or precursor to such material, e.g. an uncured liquid polymer resin) is applied to the microstructured surface of the nanovoided layer, the facets or portions of the microstructured surface may contain surface voids, e.g. in the form of pits, pockets, or tunnels, into which the conventional material may migrate depending on properties of the surface voids, properties of the conventional material, and process conditions such as residence time of the conventional material in an uncured state. With suitable material properties and process conditions, the conventional material layer may interpenetrate the nanovoided layer, as shown schematically in FIG. 3a.

FIG. 3a shows in schematic cross-section a portion of an interface between a first nanovoided layer 372 and a second layer 370 of conventional material. The interface portion may, for example, be a microscopic portion of a structured surface defined between the two layers. The nanovoided layer 372 is shown to have a shallow surface void or depression 374A, as well as a deeper surface void 374B. The surface void 374B is characterized by a first transverse dimension S1 that is closer to the interface than a second transverse dimension S2, and the deeper dimension S2 is greater than the shallower dimension S1. We may characterize layer 370 as interpenetrating the layer 372 if the layer 370 not only conforms to the general shape of the layer 372 (e.g. depression 374A), but also if material from layer 370 migrates into or substantially fills at least some deep surface voids such as void 374a, in which a transverse dimension of the void nearer the interface is smaller than a transverse dimension farther from the interface. Such interpenetration can be achieved with nanovoided materials described herein. Also shown in FIG. 3a is an interior void 370D, as well as a contour 374C which may represent an average or best-fit surface that may in some cases be used to represent the interface between the layers 370, 372. Furthermore, the dimension S3 may represent a diameter of an average-sized void. If one wished to characterize an interpenetration depth of the layer 370 with the layer 372, one may do so in a number of different ways. In one approach, as shown by the scale at the right hand side of FIG. 3a, one may determine the amount by which the material of layer 370 has advanced beyond the average surface 374C (along a direction or measurement axis perpendicular to the local average surface), and one may characterize this amount in terms of the diameter S3. In the case of FIG. 3a, this approach may yield an answer that the interpenetration depth of layer 370 with layer 372 is about 1S3, i.e., one times the diameter S3. FIG. 3c shows the interface of FIG. 3a, but where the material of layer 370 has advanced deeper into the layer 372. In the case of FIG. 3c, the same approach would yield an answer that the interpenetration depth of layer 370 with layer 372 is about 2S3, i.e., two times the diameter S3.

A second approach of characterizing the interpenetration depth is to again measure the amount by which the material of layer 370 has advanced beyond the average surface 374C, and then simply report this amount in terms of standard units of distance, e.g., micrometers or nanometers.

A third approach of characterizing the interpenetration depth is to again measure the amount by which the material of layer 370 has advanced beyond the average surface 374C, but then characterize this amount in terms of the feature height of the structured surface at issue. Reference in this regard is made to FIGS. 3b and 3d, which depict the interface between layers 370, 372 in lower magnification than in FIGS. 3a and 3c, respectively, so that the nature of the structured surface between the two layers can he seen. The structured surface is shown as having a feature height S4. The interpenetration depth in the case of FIG. 3d can be expressed by the ratio S5/S4. The interpenetration depth in the case of FIG. 3b, assuming the material of layer 370 extends a distance of about 1S3 beyond the surface 374C as shown in corresponding FIG. 3a, can be expressed by the ratio S3/S4.

In exemplary embodiments, the interpenetration depth may be for example. with regard to the first approach, in a range from 1 to 10 void diameters; with regard to the second approach, no more than 1, 10, 100, or 500 microns; with regard to the third approach, at least 5% of the feature height, or at least 10%, or at least 50%, or at least 95%, or at least 100%, or no more than 5%, or no more than 10%, or no more than 25%, or in a range from 5 to 25%, of the feature height. These exemplary ranges, however, should not be construed as limiting. The third approach of characterizing the interpenetration depth may be particularly suitable when dealing with microstructured surfaces that have particularly small feature sizes, e.g., in which the feature-to-feature pitch is less than 1 micron.

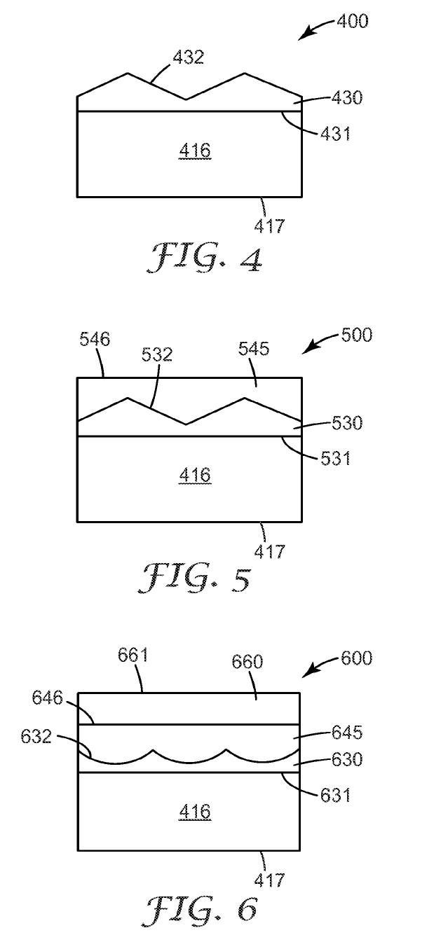

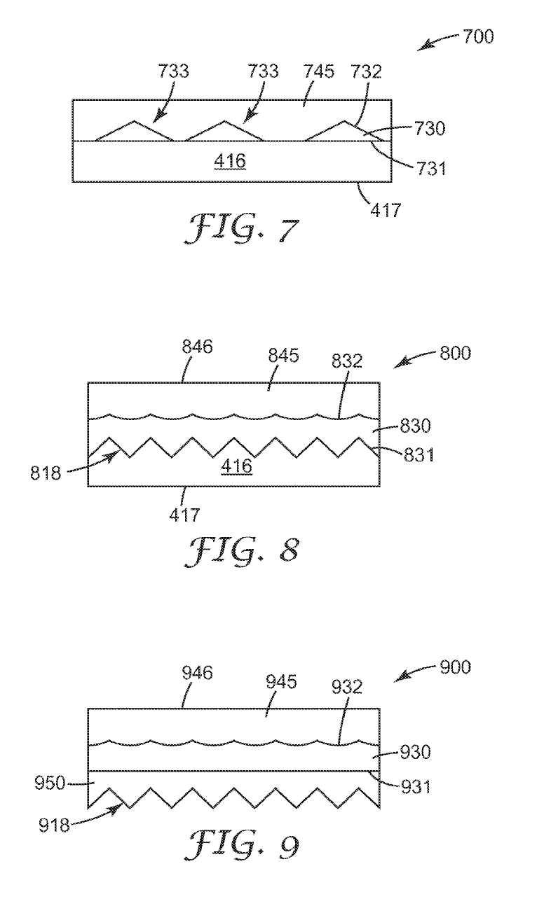

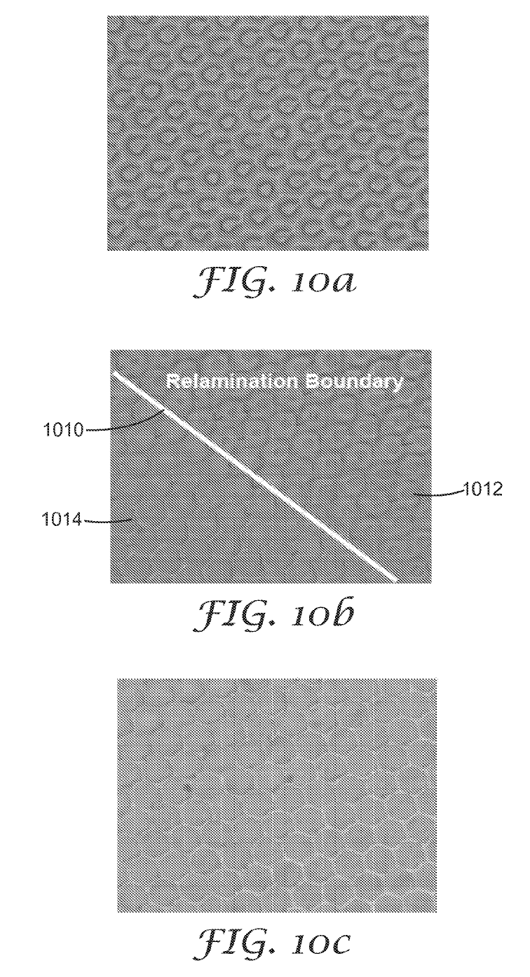

FIG. 4 is a schematic side elevational view of a nanovoided microstructured article 400. FIG. 5 is a schematic side elevational view of a backfilled nanovoided microstructured article 500. FIG. 6 is schematic side elevational view of another backfilled nanovoided microstructured article 600. Like elements in the figures are labeled with like reference numerals. These articles include respective nanovoided layers 430, 530, 630 having respective first major microstructured surfaces 432, 532, 632 and second major surfaces 431, 531, 631 opposing the respective first major microstructured surface. The nanovoided layers 430, 530, 630 and processes for forming the nanovoided layers are described above. A polymeric resin layer 416 is disposed on the respective second major surfaces 431, 531, 631 as shown, or it may be disposed on the first microstructured major surfaces 432, 532, 632, where, of course, the term “disposed on” in this regard refers only to the geometric relationship of the layers and not their relative order of fabrication.

In many of the disclosed film articles, the outer major surfaces of the film articles can be planar and coparallel. See e.g. outer surfaces 417, 546 of article 500, or outer surfaces 417, 661 of article 600. In many embodiments, the microstructured surface, which can manage light or a desired optical property of the film article, is embedded within the film article so as to substantially protect the microstructured surface. See e.g.

microstructured surface 532 of article 500, or rnicrostructured surface 632 of microstructured surface 630. In some embodiments, the nanovoided layer is a low refractive index layer (e.g., from 1.15 to 1.45 RI) such that the nanovoided layer can function like an air interface in cases where it is embedded within the film article. Microstructuring the nanovoided layer (430, 530, 630) so that it functions like an air interface, and embedding it within a film article, provides numerous advantages. The nanovoided layer 430, 530, 630 can have any useful microstructured surface structure.

The structure of the microstructured surface 432, 532, 632 can operate to manage light passing through or incident on the microstructured surface structure. In some cases, the microstructured surface structure can include refractive elements such as prisms, lenticular lenses, Fresnel elements or cylindrical lenses, for example. These refractive elements can form a regular linear or 2D array or form an irregular, pseudorandom, a serpentine pattern or random array. In some cases the microstructured surface structure may include retroreflective elements or partially retroreflective elements such as an array of cube corner elements, for example. In some cases the microstructured surface structure may include diffractive elements such as a linear or 2D grating, diffractive optical elements, or holographic elements, for example. It is understood that the microstructured surface structure and the polymeric resin layer 416 may cooperate to provide the desired optical function described herein.

The figures illustrate that the polymeric resin layer 416 is disposed on the second major surface 431, 531, 631 of the nanovoided layer. In some embodiments the second major surface 330 is a substantially planar surface. In many embodiments, the polymeric resin layer 416 is a substrate layer. The substrate layer 416 can be formed of any polymeric material useful in a roll-to-roll process. In some embodiments the substrate layer 416 can be formed of polymers such as polyethylene terapthalate (PET), polycarbonates, and acrylics. In many embodiments, the substrate layer 416 can be formed of polymers that are at least partially light transmissive, such that curing light can pass through the substrate layer and initiate the polymerization of the coating solution to form the solvent-laden nanovoided layer. In some cases, the substrate layer 416 is formed of a polymer that is at least partially UV light transmissive, such that UV curing light passes through the substrate layer and initiates the photo-polymerization of the coating solution to form the solvent laden nanovoided layer.

FIG. 5 illustrates a backfilled nanovoided microstructured article 500 where the nanovoided layer 530 separates polymeric layers 416, 545. This embodiment illustrates that the nanovoided layer 530 can form a prism interface with the polymeric layer 545. The polymeric layer 545 forms a coincident interface with the first major microstructurcd surface 532. In some cases, the polymeric layer 545 does not penetrate into the first major microstructured surface 532. In some cases, the polymeric layer 545 intersperses into the first major microstructured surface 532 at least partially filling surface voids within the first major microstructured surface 532. The depth that the polymeric layer 545 penetrates into the first major microstructured surface 532 can be controlled by selection of the polymeric layer 545 among other factors. In some cases, the polymeric layer 545 penetrates into the first major microstructured surface 532 a distance approximately equal to one void diameter of the nanovoided layer 530. In some cases, the polymeric layer 545 penetrates into the first major microstructured surface 532 a distance approximately equal to a range from two to ten void diameters of the nanovoided layer 300. In some cases, at least 1 micron or at least 2 microns of the total thickness of the nanovoided layer 530 is not penetrated by the polymeric layer 545. Reference is also made to the interpenetration discussion provided above in connection with FIGS. 3a-d.

In some embodiments the polymeric layer 545 penetrates into the first major microstructured surface 532 a distance approximately equal to 5% or less, or 10% or less of the total thickness of the nanovoided layer 530. In some embodiments the polymeric layer 545 penetrates into the first major microstructurcd surface 532 a distance approximately equal to a range from 5% to 25% of the total thickness of the nanovoided layer 530. In some embodiments the polymeric layer 545 penetrates into the first major microstructured surface 332 a distance approximately equal to 10% or more, or 50% or more, of the total thickness of the nanovoided layer 530. In some cases the polymeric layer 545 may penetrate into the first major microstructured surface 532 a distance approximately equal to 95% or more, or 100% of the total thickness of the nanovoided layer 530.

The polymeric layers 416, 545 can have any useful refractive index. In some cases one or both of the polymeric layers 416, 545 have a refractive index in a range from 1.4 to 2.0. In some cases, one or both of the polymeric layers 416, 545 may include nanoparticles, as described above.

FIG. 6 is a schematic side elevational view of another backfilled nanovoided microstructured article 600. This embodiment illustrates that an additional element 660 can be disposed on the polymeric layer 645. This embodiment illustrates that the nanovoided layer 630 can form a lenticular lens interface with the polymeric layer 645. It is understood that any of the articles described herein can include the additional element 660. In some embodiments this element 660 is a release liner, and a viscoelastic or adhesive (e.g., pressure sensitive adhesive) forms the polymeric layer 645 disposed between the release liner 660 and nanovoided layer 630. In many embodiments, the element 660 is an optical element that includes a retroreflective, refractive, or diffractive element. In some embodiments, this element 660 is an optical element such as a multi-layer optical film, an optical resin, a polarizing film, a diffusing film, a reflecting film, a retarder, a light guide, a liquid crystal display panel, and/or an optical fiber. Polarizing films include cholesteric reflective polarizers, wire grid polarizers, fiber polarizers, absorbing polarizers, a blend polarizer, and a multilayer polarizer. It is understood that the additional element 660 can be disposed on the polymeric layers 416 or the nanovoided layer (e.g., layers 430, 530, 630) also. Any suitable type of reflective polarizer may be used such as, for example, a multilayer optical film (MOF) reflective polarizer, a diffusely reflective polarizing film (DRPF) having a continuous phase and a disperse phase, such as a VikuitiTM Diffuse Reflective Polarizer Film (“DRPF”) available from 3M Company, St. Paul, Minn., a wire grid reflective polarizer described in, for example, U.S. Pat. No. 6,719,426 (Magarill et al.), or a cholesteric reflective polarizer.

A multi-layer optical film (MOF) reflective polarizer can be formed of alternating layers of different polymer materials, where one of the sets of alternating layers is formed of a birefringent material, where the refractive indices of the different materials are matched for light polarized in one linear polarization state and unmatched for light in the orthogonal linear polarization state. In such cases, an incident light component in the matched polarization state is substantially transmitted through the reflective polarizer layer and an incident light component in the unmatched polarization state is substantially reflected by the reflective polarizer layer. In some cases, an MOF reflective polarizer layer can include a stack of inorganic dielectric layers.

A reflective polarizer element can be or include a circular reflective polarizer, where light circularly polarized in one sense, which may be the clockwise or counterclockwise sense (also referred to as right or left circular polarization), is preferentially transmitted and light polarized in the opposite sense is preferentially reflected. One type of circular polarizer includes a cholesteric liquid crystal polarizer.

FIG. 7 is a schematic side elevational view of another backfilled nanovoided microstructured article 700, where element 745 represents a polymeric layer, element 730 represents a nanovoided layer, and elements 733 represent discrete prism structures of the nanovoided layer 730. This embodiment illustrates that the nanovoided layer 730 can form discrete prism interface structures 733 with the polymeric layer 745. The discrete prism interface structures 733 have a first major microstructured surface 732 and a second major surface 731 opposing the first major microstructured surface 732. The first major microstructured surface 732 forms the prism interface and is coincident with the polymeric layer 745. The second major surface 731 is coincident with the substrate 416. The discrete prism interface structures 733 can be spaced apart in a regular or irregular period on the substrate 416. While the prism interface structures 733 are illustrated without “land” adjoining them, it is understood that “land” could be adjoining the prism interface structures 733.

FIG. 8 is a schematic side elevation view of another backfilled nanovoided microstructured article 800, where element 845 represents a polymeric layer, and element 830 represents a nanovoided layer having a first major microstructured surface 832 and a microstructured second major surface 831. This embodiment illustrates that the nanovoided layer can be coated onto a microstructured polymeric layer 416 to form a microstructured second major surface 831 that is coincident with the microstructured polymeric layer 416. The illustrated coincident interface 818 at the second major surface 831 forms a prism interface, but it is understood that this interface 818 could have any microstructured structure as described above. The illustrated first major microstructured surface 832 forms a coincident interface with the polymeric layer 845. This coincident interface forms a lenticular structure interface between the nanovoided layer 830 and the polymeric layer 845, however it is understood that this interface 832 could have any microstructured structure as described above. In this embodiment the outer surfaces 417, 846 of the backfilled nanovoided microstructured article 800 are substantially co-parallel and substantially planar. In some embodiments the microstructured polymeric layer 416 may be a release liner or layer that can be separated from the microstructured second major surface 831.

FIG. 9 is a schematic side elevation view of another backfilled nanovoided microstructurcd article 900, where element 945 represents a polymeric layer, clement 930 represents a nanovoided layer having a first major microstructured surface 932 and a second major surface 931, and element 950 represents another polymeric layer. This embodiment illustrates that the nanovoided layer 930 can be coated onto a microstructured polymeric layer 950 where the microstructured polymeric layer surface 918 of the layer 950 is directed away from the nanovoided layer 930. The illustrated microstructured polymeric layer surface 918 forms a prism structure, but it is understood that this surface 918 could have any microstructured structure as described above. The illustrated first major microstructured surface 932 forms a coincident interface with the polymeric layer 945. This coincident interface with the polymeric layer 945 forms a lenticular structure interface between the nanovoided layer 930 and the polymeric layer 945, but it is understood that this interface 918 could have any microstructured structure as described above. An outer surface 946 is illustrated as being planar. The second major surface 931 of the nanovoided layer 930 is disposed on a planar side of the microstructured polymeric layer 950 opposing the microstructured polymeric layer surface 918.

The polymeric layers 545, 645, 745, 845, and 945 can be derived from a polymerizable material. The polymerizable material can be any material that can be polymerized by various conventional anionic, cationic, free radical, or other polymerization technique, which can be initiated chemically, thermally, or can be initiated with actinic radiation, provided that the composition of the polymerizable material and polymerization mechanism enables the formation of a structured interface between the structured nanovoided layer and the backfill polymer, i.e the polymerizable material does not fully infiltrate the nanovoided layer. In many embodiments this may require fast formation of the polymeric layer (545, 645, 745, 845, and 945). Suitable polymerization processes can be initiated by the proper choice of materials and processes such as the use actinic radiation including, e.g., visible and ultraviolet light, electron beam radiation, and combinations thereof, among other means.

The polymeric layer 545, 645, 745, 845, and 945 may also comprise thermoplastic resins. Thermoplastic resins can be applied in a coating process as high molecular weight resins dissolved in a solvent or mixture of solvents. Alternatively, thermoplastic resins can be applied in the molten state by processes such as melt casting, extrusion, or injection molding. In some embodiments, the use of high molecular weight polymeric materials as the polymeric backfill layer 545, 645, 745, 845, 945 can limit the level of interpenetration of the polymeric layer into the nanovoided structure where the average radius of gyration of the polymer chains is larger than the average void diameter of the nanovoided layer. In many embodiments, one or both of the polymeric layers (see e.g. elements 416, 545, 645, 745, 845, 945, and 950) are viscoelastic materials, such as a pressure sensitive adhesive material, for example. In general, viscoelastic materials exhibit both elastic and viscous behavior when undergoing deformation. Elastic characteristics refer to the ability of a material to return to its original shape after a transient load is removed. One measure of elasticity for a material is referred to as the tensile set value which is a function of the elongation remaining after the material has been stretched and subsequently allowed to recover (destretch) under the same conditions by which it was stretched. If a material has a tensile set value of 0%, then it has returned to its original length upon relaxation, whereas if the tensile set value is 100%, then the material is twice its original length upon relaxation. Tensile set values may be measured using ASTM D412. Useful viscoelastic materials may have tensile set values of greater than about 10%, greater than about 30%, or greater than about 50%; or from about 5 to about 70%, from about 10 to about 70%, from about 30 to about 70%, or from about 10 to about 60%.

Viscous materials that arc Newtonian liquids have viscous characteristics that obey Newton's law, which states that stress increases linearly with shear gradient. A liquid does not recover its shape as the shear gradient is removed. Viscous characteristics of useful viscoelastic materials include flowability of the material under reasonable temperatures such that the material does not decompose.

One or both of the polymeric layers in the disclosed articles can have properties that facilitate sufficient contact or wetting with at least a portion of the nanovoided microstructured layer such that the one or both polymeric layers are optically coupled to the nanovoided microstructured layer. The one or both polymeric layers can be generally soft, compliant, and flexible. Thus, the one or both polymeric layers may have an elastic modulus (or storage modulus G′) such that sufficient contact can be obtained, and a viscous modulus (or loss modulus G″) such that the layer doesn't flow undesirably, and a damping coefficient (G″/G′, tan D) for the relative degree of damping of the layer.

Useful viscoelastic materials may have a storage modulus, G′, of less than about 300,000 Pa, measured at 10 rad/sec and a temperature of from about 20 to about 22° C. Useful viscoelastic materials may have a storage modulus, G′, of from about 30 to about 300,000, or from about 30 to about 150,000, or from about 30 to about 30,000 Pa, measured at 10 rad/sec and a temperature of from about 20 to about 22° C. Useful viscoelastic materials may have a storage modulus, G′, of from about 30 to about 150,000 Pa, measured at 10 rad/sec and a temperature of from about 20 to about 22° C., and a loss tangent (tan d) of from about 0.4 to about 3. Viscoelastic properties of materials can be measured using Dynamic Mechanical Analysis according to, for example, ASTM D4065, D4440, and D5279.

In some embodiments, one or both of the polymeric layers (see e.g. elements 416, and 545, 645, 745, 845, 945, and 950) is a pressure sensitive adhesive (PSA) layer as described in the Dalquist criterion line (as described in Handbook of Pressure Sensitive Adhesive Technology, Second Ed., D. Satas, ed., Van Nostrand Reinhold, New York, 1989.) In some embodiments, one or both of the polymeric layers can be formed of two or more PSA layers. For example, one or both of the polymeric layers can include an inner PSA layer disposed between an outer PSA layer and the nanovoided microstructured layer. The inner PSA layer can have physical properties that are different than the outer PSA layer.

One or both of the polymeric layers may have a particular peel force or at least exhibit a peel force within a particular range. For example, the polymeric layers may have a 90° peel force of from about 10 to about 3000 Win, from about 50 to about 3000 Win, from about 300 to about 3000 Win, or from about 500 to about 3000 Win. Peel force may be measured using a peel tester from TMASS.

The polymeric layers may have a refractive index in the range of from about 1.3 to about 2.6, from about 1.4 to about 1.7, or from about 1.46 to about 1.7. The particular refractive index or range of refractive indices selected for the polymeric layers may depend on the overall design of the optical device.

The polymeric layers (see e.g. elements 416, and 545, 645, 745, 845, 945, and 950) generally include at least one polymer. The polymeric layers may include at least one PSA. PSAs are useful for adhering together adherends and exhibit properties such as: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process. A quantitative description of PSAs can be found in the Dahlquist reference cited above.

Useful PSAs include those based on natural rubbers, synthetic rubbers, styrene block copolymers, (meth)acrylic block copolymers, polyvinyl ethers, polyolefins, and poly(meth)acrylates. As used herein, (meth)acrylic refers to both acrylic and methacrylic species and likewise for (meth)acrylate.

Useful PSAs include (meth)acrylates, rubbers, thermoplastic elastomers, silicones, urethanes, and combinations thereof. In some embodiments, the PSA is based on a (meth)acrylic PSA or at least one poly(meth)acrylate. Herein, (meth)acrylate refers to both acrylate and methacrylate groups. Particularly preferred poly(meth)acrylates are derived from: (A) at least one monoethylenically unsaturated alkyl (meth)acrylate monomer; and (B) at least one monoethylenically unsaturated free-radically copolymerizable reinforcing monomer. The reinforcing monomer has a homopolymer glass transition temperature (Tg) higher than that of the alkyl (meth)acrylate monomer and is one that increases the Tg and cohesive strength of the resultant copolymer. Herein, “copolymer” refers to polymers containing two or more different monomers, including terpolymers, tetrapolymers, etc.

Monomer A, which is a monoethylenically unsaturated alkyl (meth)acrylate, contributes to the flexibility and tack of the copolymer. Preferably, monomer A has a homopolymer Tg of no greater than about 0° C. Preferably, the alkyl group of the (meth)acrylate has an average of about 4 to about 20 carbon atoms, and more preferably, an average of about 4 to about 14 carbon atoms. The alkyl group can optionally contain oxygen atoms in the chain thereby forming ethers or alkoxy ethers, for example. Examples of monomer A include, but are not limited to, 2-methylbutyl acrylate, isooctyl acrylate, lauryl acrylate, 4-methyl-2-pentyl acrylate, isoamyl acrylate, sec-butyl acrylate, n-butyl acrylate, n-hexyl acrylate, 2-ethylhexyl acrylate, n-octyl acrylate, n-decyl acrylate, isodecyl acrylate, isodecyl methacrylate, and isononyl acrylate. Benzyl acrylate may also be used. Other examples include, but are not limited to, poly-ethoxylated or -propoxylated methoxy (meth)acrylates such as acrylates of CARBOWAX (commercially available from Union Carbidc) and NK ester AM90G (commercially available from Shin Nakamura Chemical, Ltd., Japan). Preferred monoethylenically unsaturated (meth)acrylates that can be used as monomer A include isooctyl acrylate, 2-ethyl-hexyl acrylate, and n-butyl acrylate. Combinations of various monomers categorized as an A monomer can be used to make the copolymer.

Monomer B, which is a monoethylenically unsaturated free-radically copolymerizable reinforcing monomer, increases the Tg and cohesive strength of the copolymer. Preferably, monomer B has a homopolymer Tg of at least about 10° C., for example, from about 10 to about 50° C. More preferably, monomer B is a reinforcing (meth)acrylic monomer, including an acrylic acid, a methacrylic acid, an acrylamide, or a (meth)acrylate. Examples of monomer B include, but are not limited to, acrylamides, such as acrylamide, methacrylamide, N-methyl acrylamide, N-ethyl acrylamide, N-hydroxyethyl acrylamide, diacetone acrylamide, N,Ndimethyl acrylamide, N, N-diethyl acrylamide, N-ethyl-N-aminoethyl acrylamide, N-ethyl-N hydroxyethyl acrylamide, N,N-dihydroxyethyl acrylamide, t-butyl acrylamide, N,Ndimethylaminoethyl acrylamide, and N-octyl acrylamide. Other examples of monomer B include itaconic acid, crotonic acid, maleic acid, fumaric acid, 2,2-(diethoxy)ethyl acrylate, 2-hydroxyethyl acrylate or methacrylate, 3-hydroxypropyl acrylate or methacrylate, methyl methacrylate, isobornyl acrylate, 2-(phenoxy)ethyl acrylate or methacrylate, biphenylyl acrylate, t-butylphenyl acrylate, cyclohexyl acrylate, dimethyladamantyl acrylate, 2-naphthyl acrylate, phenyl acrylate, N-vinyl formamide, N-vinyl acetamide, N-vinyl pyrrolidone, and Nvinyl caprolactam. Preferred reinforcing acrylic monomers that can be used as monomer B include acrylic acid and acrylamide. Combinations of various reinforcing monoethylenically unsaturated monomers categorized as a B monomer can be used to make the copolymer.

In some embodiments, the (meth)acrylate copolymer is formulated to have a resultant Tg of less than about 0° C. and more preferably, less than about −10° C. Such (meth)acrylate copolymers preferably include about 60 to about 98% by weight of at least one monomer A and about 2 to about 40% by weight of at least one monomer B, both relative to the total weight of the (meth)acrylate copolymer. Preferably, the (meth)acrylate copolymer has about 85 to about 98% by weight of at least one monomer A and about 2 to about 15% by weight of at least one monomer B, both relative to the total weight of the (meth)acrylatc copolymer.

Useful rubber-based PSAs are generally of two classes, natural rubber-based or synthetic rubber-based. Useful natural rubber-based PSAs generally contain masticated natural rubber, for example, from about 20 to about 75% by weight of one or more tackifying resins, from about 25 to about 80% by weight of natural rubber, and typically from about 0.5 to about 2.0% by weight of one or more antioxidants, all relative to the total weight of the masticated rubber. Natural rubber may range in grade from a light pale crepe grade to a darker ribbed smoked sheet and includes such examples as CV-60, a controlled viscosity rubber grade and SMR-5, a ribbed smoked sheet rubber grade.

Tackifying resins used with natural rubbers generally include but are not limited to wood rosin and its hydrogenated derivatives; terpene resins of various softening points, and petroleum-based resins, such as, the ESCOREZ 1300 series of C₅ aliphatic olefin-derived resins from Exxon.

Antioxidants may be used with natural rubbers in order to retard oxidative attack on the rubber which can result in loss of cohesive strength of the adhesive. Useful antioxidants include but are not limited to amines, such as N-N′ di-beta-naphthyl-1,4-phenylenediamine, available as AGERITE Resin D from R. T. Vanderbilt Co., Inc.; phenolics, such as 2,5-di-(tamyl) hydroquinonc, available as SANTOVAR A, available from Monsanto Chemical Co.; tetrakis[methylene 3-(3′, 5′-di-tert-butyl-4′-hydroxyphenyl)propianate]methane, available as IRGANOX 1010 from Ciba-Geigy Corp.; 2,2′-methylenebis(4-methyl-6-tert butyl phenol), known as Antioxidant 2246; and dithiocarbamates, such as zinc dithiodibutyl carbamate. Curing agents may be used to at least partially vulcanize (crosslink) the PSA.

Useful synthetic rubber-based PSAs include adhesives that are generally rubbery elastomers, which are either self-tacky or non-tacky and require tackifiers. Self-tacky synthetic rubber PSAs include, for example, butyl rubber, a copolymer of isobutylene with less than 3 percent isoprene, polyisobutylene, a homopolymer of isoprene, polyhutadiene, or styrene/butadiene rubber. Butyl rubber PSAs often contain an antioxidant such as zinc dibutyl dithiocarbamatc. Polyisobutylene PSAs do not usually contain antioxidants. Synthetic rubber PSAs, which generally require tackifiers, are also generally easier to melt process as compared to natural rubber PSAs which typically having very high molecular weights. They comprise polybutadiene or styrene/butadiene rubber, from 10 parts to 200 parts of a tackifier, and generally from 0.5 to 2.0 parts per 100 parts rubber of an antioxidant such as IRGANOX 1010. An example of a synthetic rubber is AMERIPOL 101 1A, a styrene/butadiene rubber available from BF Goodrich. Tackifiers that may be used with synthetic rubber PSAs include derivatives of rosins such as FORAL 85, a stabilized rosin ester from Hercules, Inc.; the SNOWTACK series of gum rosins from Tenneco; the AQUATAC series of tall oil rosins from Sylvachem; synthetic hydrocarbon resins such as the PICCOLYTE A series, polyterpenes from Hercules, Inc.; the ESCOREZ 1300 series of C₅ aliphatic olefin-derived resins; and the ESCOREZ 2000 Series of C₉ aromatic/aliphatic olefin-derived resins. Curing agents may be added to at least partially vulcanize (crosslink) the PSA.

Useful thermoplastic elastomer PSAs include styrene block copolymer PSAs which generally include elastomers of the A-B or A-B-A type, where A represents a thermoplastic polystyrene block and B represents a rubbery block of polyisoprene, polybutadiene, or poly(ethylene/butylene), and resins. Examples of the various block copolymers useful in block copolymer PSAs include linear, radial, star and tapered styrene-isoprene block copolymers such as KRATON D1107P, available from Shell Chemical Co., and EUROPRENE SOL TE 9110, available from EniChem Elastomers Americas, Inc.; linear styrene-(ethylene-butylene) block copolymers such as KRATON G1657, available from Shell Chemical Co.; linear styrene-(ethylene-propylene) block copolymers such as KRATON G1750X, available from Shell Chemical Co.; and linear, radial, and star styrene-butadiene block copolymers such as KRATON D1118X, available from Shell Chemical Co., and EUROPRENE SOL TE 6205, available from EniChem Elastomers Americas, Inc. The polystyrene blocks tend to form domains in the shape of spheroids, cylinders, or plates that causes the block copolymer PSAs to have two phase structures.

Resins that associate with the rubber phase may be used with thermoplastic elastomer PSAs if the elastomer itself is not tacky enough. Examples of rubber phase associating resins include aliphatic olefin-derived resins, such as the ESCOREZ 1300 series and the WINGTACK series, available from Goodyear; rosin esters, such as the FORAL series and the STAYBELITE Ester 10, both available from Hercules, Inc.; hydrogenated hydrocarbons, such as the ESCOREZ 5000 series, available from Exxon; polyterpenes, such as the PICCOLYTE A series; and terpene phenolic resins derived from petroleum or tcrpcntinc sources, such as PICCOFYN A100, available from Hercules, Inc.

Resins that associate with the thermoplastic phase may be used with thermoplastic elastomer PSAs if the elastomer is not stiff enough. Thermoplastic phase associating resins include polyaromatics, such as the PICCO 6000 series of aromatic hydrocarbon resins, available from Hercules, Inc.; coumarone-indene resins, such as the CUMAR series, available from Neville; and other high-solubility parameter resins derived from coal tar or petroleum and having softening points above about 85° C., such as the AMOCO 18 series of alphamethyl styrene resins, available from Amoco, PICCOVAR 130 alkyl aromatic polyindene resin, available from Hercules, Inc., and the PICCOTEX series of alphamethyl styrene/vinyl toluene resins, available from Hercules.

Useful silicone PSAs include polydiorganosiloxanes and polydiorganosiloxanc polyoxamides. Useful silicone PSAs include silicone-containing resins formed from a hyrosilylation reaction between one or more components having silicon-bonded hydrogen and aliphatic unsaturation. Examples of silicon-bonded hydrogen components include high molecular weight polydimethylsiloxane or polydimethyldiphenylsiloxane, and that contain residual silanol functionality (SiOH) on the ends of the polymer chain. Examples of aliphatic unsaturation components include siloxanes functionalized with two or more (meth)acrylate groups or block copolymers comprising polydiorganosiloxanc soft segments and urea terminated hard segments. Hydrosilylation may be carried out using platinum catalysts.

Useful silicone PSAs may comprise a polymer or gum and an optional tackifying resin. The tackifying resin is generally a three-dimensional silicate structure that is endcapped with trimethylsiloxy groups (OSiMe₃) and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif. Manufacture of typical silicone PSAs is described in U.S. Pat. No. 2,736,721 (Dexter). Manufacture of silicone urea block copolymer PSAs is described in U.S. Pat. No. 5,214,119 (Leir et al).

Useful silicone PSAs may also comprise a polydiorganosiloxane polyoxamide and an optional tackifier as described in U.S. Pat. No. 7,361,474 (Sherman et al.). For example, the polydiorganosiloxane polyoxamide may comprise at least two repeat units of Formula is

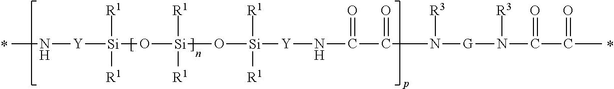

wherein: each R¹ is independently an alkyl, haloalkyl, aralkyl, alkenyl, aryl, or aryl substituted with an alkyl, alkoxy, or halo, wherein at least 50 percent of the R¹ groups are methyl; each Y is independently an alkylene, aralkylene, or a combination thereof; G is a divalent residue equal to a diamine of formula R₃HN-G-NHR₃ minus the two —NHR₃ groups; R₃ is hydrogen or alkyl or R₃ taken together with G and with the nitrogen to which they are both attached forms a heterocyclic group; n is independently an integer of 40 to 1500; and p is an integer of 1 to 10; and an asterisk (*) indicates a site of attachment of the repeat unit to another group in the copolymer. The copolymer may have a first repeat unit where p is equal to 1 and a second repeat unit where p is at least 2. G may comprise an alkylene, heteroalkylene, arylene, aralkylcnc, polydiorganosiloxane, or a combination thereof. The integer n may be an integer of 40 to 500. These polydiorganosiloxane polyoxamides can be used in combination with a tackifier. Useful tackifiers include silicone tackifying resins as described in U.S. Pat. No. 7,090,922 (Zhou et al.). Some of these silicone-containing PSAs may be heat activated.

The PSA may be crosslinked to the extent that the crosslinks do not interfere with desired properties of the viscoelastic lightguide. Generally, the PSA may be crosslinked to the extent that the crosslinks do not interfere with the viscous characteristics of the adhesive layer. Crosslinking is used to build molecular weight and strength of the PSA. The degree of crosslinking may be selected based upon the application for which the lightguide is intended. Crosslinking agents may be used to form chemical crosslinks, physical crosslinks or a combination thereof. Chemical crosslinks include covalent bonds and ionic bonds. Covalent crosslinks may be formed by incorporating a multi-functional monomer in the polymerization process, followed by curing using, e.g., ultraviolet radiation, heat, ionizing radiation, moisture, or a combination thereof.

Physical crosslinks include noncovalent bonds and are generally thermally reversible. Examples of physical crosslinks include high Tg (i.e., those having a Tg higher than room temperature, preferably higher than 70° C.) polymer segments included, for example, in thermoplastic elastomer block copolymers. Such segments aggregate to form physical crosslinks that dissipate upon heating. If a physically crosslinked PSA is used such as a thermoplastic elastomer, the embossing typically is carried out at temperature below, or even substantially below, the temperature at which the adhesive flows. Hard segments include the styrene macromers of U.S. Pat. No. 4,554,324 (Husman et al.) and/or acid/base interactions (i.e., those involving functional groups within the same polymer or between polymers or between a polymer and an additive) such as polymeric ionic crosslinking as described in WO 99/42536 (Stark et al.).

Suitable crosslinking agents are also disclosed in U.S. Pat. Nos. 4,737,559 (Kellen et al.), 5,506,279 (Babu et al.), and 6,083,856 (Joseph et al.). The crosslinking agent can be a photocrosslinking agent, which, upon exposure to ultraviolet radiation (e. g., radiation having a wavelength of from about 250 to about 400 nm), causes the copolymer to crosslink. The crosslinking agent is used in an effective amount, by which is meant an amount that is sufficient to cause crosslinking of the PSA to provide adequate cohesive strength to produce the desired final adhesion properties. Preferably, the crosslinking agent is used in an amount of about 0.1 part to about 10 parts by weight, based on the total weight of monomers.

In some embodiments, the adhesive layer is a PSA formed from a (meth)acrylate block copolymer as described in U.S. Pat. No. 7,255,920 (Everaerts et al.). In general, these (meth)acrylate block copolymers comprise: at least two A block polymeric units that are the reaction product of a first monomer composition comprising an alkyl methacrylate, an aralkyl methacrylate, an aryl methacrylate, or a combination thereof, each A block having a Tg of at least 50° C., the methacrylate block copolymer comprising from 20 to 50 weight percent A block; and at least one B block polymeric unit that is the reaction product of a second monomer composition comprising an alkyl (meth)acrylate, a heteroalkyl (meth)acrylate, a vinyl ester, or a combination thereof, the B block having a Tg no greater than 20° C., the (meth)acrylate block copolymer comprising from 50 to 80 weight percent B block; wherein the A block polymeric units are present as nanodomains having an average size less than about 150 nm in a matrix of the B block polymeric units.

In some embodiments, the adhesive layer is a clear acrylic PSA, for example, those available as transfer tapes such as VHBTM Acrylic Tape 4910F from 3M Company and 3M™ Optically Clear Laminating Adhesives (8140 and 8180 series). In some embodiments, the adhesive layer is a PSA formed from at least one monomer containing a substituted or an unsubstituted aromatic moiety as described in U.S. Pat. No. 6,663,978 B1 (Olson et al.):

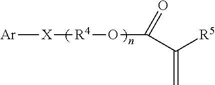

wherein Ar is an aromatic group which is unsubstituted or substituted with a substituent selected from the group consisting of Br_{y} and R⁶_{z} wherein y represents the number of brominesubstitucnts attached to the aromatic group and is an integer of from 0 to 3, R⁶ is a straight or branched alkyl of from 2 to 12 carbons, and z represents the number of R⁶ substituents attached to the aromatic ring and is either 0 or 1 provided that both y and z are not zero; X is either O or S; n is from 0 to 3; R⁴ is an unsubstituted straight or branched alkyl linking group of from 2 to 12 carbons; and R⁵ is either H or CH₃.

In some embodiments, the adhesive layer is a copolymer as described in U.S. Patent Application Publication U.S. 2009/0105437 (Determan et al.), comprising (a) monomer units having pendant bephenyl groups and (b) alkyl (meth)acrylate monomer units. In some embodiments, the adhesive layer is a copolymer as described in U.S. Patent Application Publication U.S. 2010/0222496 (Determan et al.), comprising (a) monomer units having pendant carbazole groups and (b) alkyl (meth)acrylate monomer units. In some embodiments, the adhesive layer is an adhesive as described in PCT publication WO 2009/061673 (Schaffer et al.), comprising a block copolymer dispersed in an adhesive matrix to form a Lewis acid-base pair. The block copolymer comprises an AB block copolymer, and the A block phase separates to form microdomains within the B block/adhesive matrix. For example, the adhesive matrix may comprise a copolymer of an alkyl (meth)acrylate and a (meth)acrylate having pendant acid functionality, and the block copolymer may comprise a styrene-acrylate copolymer. The microdomains may be large enough to forward scatter incident light, but not so large that they backscatter incident light. Typically these microdomains are larger than the wavelength of visible light (about 400 to about 700 nm). In some embodiments the microdomain size is from about 1.0 to about 10 um.

The adhesive layer may include a stretch releasable PSA. Stretch releasable PSAs are PSAs that can be removed from a substrate if they arc stretched at or nearly at a zero degree angle. In some embodiments, the viscoelastic lightguide or a stretch release PSA used in the viscoelastic lightguide has a shear storage modulus of less than about 10 MPa when measured at 1 rad/sec and −17° C., or from about 0.03 to about 10 MPa when measured at 1 rad/sec and −17° C. Stretch releasable PSAs may be used if disassembling, reworking, or recycling is desired. In some embodiments, the stretch releasable PSA may include a silicone-based PSA as described in U.S. Pat. No. 6,569,521 (Sheridan et al.) or PCT publication WO 2009/089137 (Sherman et al.) and PCT publication WO 2009/114683 (Determan et al.). Such silicone-based PSAs include compositions of an MQ tackifying resin and a silicone polymer. For example, the stretch releasable PSA may comprise an MQ tackifying resin and an elastomeric silicone polymer selected from the group consisting of urea-based silicone copolymers, oxamide-based silicone copolymers, amide-based silicone copolymers, urethane-based silicone copolymers, and mixtures thereof

The adhesive layer may include one or more repositionable pressure sensitive adhesive layers. In some embodiments, a temporarily repositionable pressure sensitive adhesive compositions is a blend of a silicone-modified pressure sensitive adhesive component, a high Tg polymer component and a crosslinker. The silicone-modified pressure sensitive adhesive includes a copolymer that is the reaction product of an acidic or basic monomer, a (meth)acrylic or vinyl monomer, and a silicone macromer. The high Tg polymer component contains acid or base functionality such that when mixed, the silicone-modified pressure sensitive adhesive component and the high Tg polymer component form an acid-base interaction. These temporarily repositionable pressure sensitive adhesive compositions are described in WO 2009/105297 (Sherman et al.).

In some embodiments, the repositionable pressure sensitive adhesive layer is formed of a class of non-silicone urea-based adhesives, specifically pressure sensitive adhesives. These urea based adhesives are prepared from curable non-silicone urea-based reactive oligomers. The reactive oligomers contain free radically polymerizable groups. These non-silicone urea-based adhesives are prepared by the polymerization of reactive oligomers with the general formula X-B-X, where X is an ethylenically unsaturated group and B is a unit free of silicone and containing urea groups. The reactive oligomers can be prepared from polyamines through chain extension reactions using diaryl carbonates followed by capping reactions. These non-silicone urea-based rcpositionable pressure sensitive adhesive compositions are described in WO 2009/085662 (Sherman et al.).

In some embodiments, the repositionable pressure sensitive adhesive layer is formed of a class of non-silicone urethane-based adhesives, specifically pressure sensitive adhesives. These urethane-based adhesives include a cured mixture of at least one reactive oligomer with the general formula X-A-B-A-X, wherein X comprises an ethylenically unsaturated group, B comprises a non-silicone unit with a number average molecular weight of 5,000 grams/mole or greater, and A comprises a urethane linking group, wherein the adhesive is optically clear, self wetting and removable. These non-silicone urethane-based repositionable pressure sensitive adhesive compositions are described in U.S. Provisional Application Ser. No. 61/178514 filed May 15, 2009 (Attorney Docket number 65412US002).

In some embodiments, a temporarily repositionable pressure sensitive adhesive compositions includes siloxane moieties at a siloxane-rich surface of the pressure sensitive adhesive. These temporarily repositionable pressure sensitive adhesive compositions are described in PCT publication WO 2006/031468 (Sherman et al.) and U.S. Patent Application Publication U.S. 2006/0057367 (Sherman et al.).

In some embodiments the backfill layer 545, 645, 745, 845, and 945 is inorganic in nature and is deposited by either Plasma Enhanced Chemical Vapor Deposition or

Physical vapor Deposition techniques. Examples of such layers are silicon nitride, silicon carbide, silica, titania, and zirconia. Such inorganic layers can provide unique properties to the structured backfill layer, for example high refractive indices that cannot be achieved with typical organic polymeric materials.

### EXAMPLES

### Examples Section 1

### 1. Reactive Nanoparticles

In a 2 liter three-neck flask, equipped with a condenser and a thermometer, 960 grams of IPA-ST-UP organosilica elongated particles (available from Nissan Chemical Inc., Houston, Tex.), 19.2 grams of deionized water, and 350 grams of 1-methoxy-2-propanol were mixed under rapid stirring. The elongated particles had a diameter in a range from about 9 nm to about 15 nm and a length in a range of about 40 nm to about 100 nm. The particles were dispersed in a 15.2 % wt IPA. Next, 22.8 grams of Silquest A-174 silane (available from GE Advanced Materials, Wilton, Conn.) was added to the flask. The resulting mixture was stirred for 30 minutes.

The mixture was kept at 81 degrees centigrade for 16 hours, and then allowed to cool to room temperature. Next, about 950 grams of solvent were removed from the solution using a rotary evaporator with a 40 degrees centigrade water-bath, resulting in a 41.7 % wt A-174-modified elongated silica clear dispersion in 1-methoxy-2-propanol.

### 2. Coating Solution

A coating solution was made by first dissolving CN 9893 (Available from Sartomer, Sartomer Company, Inc. 502 Thomas Jones Way, Exton, Pa. 19341, it is a Difunctional aliphatic urethane oligomer) in ethyl acetate under ultrasonic agitation. Other ingredients were then added with stirring to form a homogenous solution. The coating formulation is provided in Table 1.

TABLE 1
Coating solution formulation

| | % Solid | Amount (g) |
|---|---|---|
| A-174 UP Silica | 40.90% | 69.20 |
| CN9893 | 100.00% | 5.70 |
| SR444 | 100.00% | 22.60 |
| EA | 0.00% | 33.40 |
| IPA | 0.00% | 33.40 |
| Irgacure 184 | 100.00% | 0.70 |
| Irgacure 819 | 100.00% | 0.14 |
| Total | | 165.10 |

### 3. Microreplication Tools

Two types of microreplication tools were used to build the optical elements. The first tool type was a modified diamond-turned metallic cylindrical tool. Patterns were cut into the copper surface of the tool using a precision diamond turning machine. The resulting copper cylinders with precision cut features were nickel plated and coated with PA11-4. Plating and coating process of the copper master cylinder is a common practice used to promote release of cured resin during the microreplication process.

The second tool type is a film replicate from the precision cylindrical tool described above. An acrylate resin comprising acrylate monomers and a photoinitiator was cast onto a PET support film (2 mil) and then cured against a precision cylindrical tool using ultraviolet light. The surface of the resulting structured film was coated with a silane release agent (tetramethylsilane) using a plasma-enhanced chemical vapor deposition (PECVD) process. The surface-treated structured film was then used as a tool by wrapping and securing a piece of the film, structured side out, to the surface of a casting roll.

TABLE 2
Microreplication tools used in the fabrication
of structured ultra low index materials

| | | Feature | | |
|---|---|---|---|---|
| Tool Name | Type | Height | Pitch | Properties |
| cylindrical lens 1 | copper | 5.5 μm | 29.5 μm | concave linear array, |
| | | | | 22.6 μm radius |
| cylindrical lens 2 | film | 5.1 μm | 45.5 μm | convex linear array, |
| | | | | 53.0 μm radius |
| linear prism 1 | copper | 25.6 μm | 29.5 μm | linear array, |
| | | | | 60° included angle |
| linear prism 2 | film | 2.9 μm | 81.6 μm | linear array, |
| | | | | 172° included angle |
| microlens array | film | 11 μm | ~40 μm | convex hexagonal |
| | | | | array, |

### 4. Nanovoided Layer Microreplication

A film microreplication apparatus was employed to create microstructured nanovoided structures on a continuous film substrate. The apparatus included: a needle die and syringe pump for applying the coating solution; a cylindrical microreplication tool;

a rubber nip roll against the tool; a series of UV-LED arrays arranged around the surface of the microreplication tool; and a web handling system to supply, tension, and take up the continuous film. The apparatus was configured to control a number of coating parameters manually including tool temperature, tool rotation, web speed, rubber nip roll/tool pressure, coating solution flow rate, and UV-LED irradiance. An example process is illustrated in FIG. 1.

The coating solution (see above) was applied to a 3 mil PET film (DuPont Melinex film primed on both sides) adjacent to the nip formed between the tool and the film. The flow rate of the solution was adjusted to about 0.25 ml/min and the web speed was set to 1 ft/min so that a continuous, rolling bank of solution was maintained at the nip.

In one of the examples, 3M™ Vikuiti™ Enhanced Specular Reflector (3M ESR) film, rather than the PET film, was used as the substrate on which the coating solution was applied. In this example, sheeted samples of the ESR film were attached to the PET carrier film as the film moved through the line. Primed sheets of the ESR film, with their primed sides facing out, were attached onto the continuous web of 3-mil DuPont Melinex two-sided primed PET film using removable adhesive tape.

Although ESR is a reflective film, the reflectivity is decreased when it is in contact with a fluid (e.g. the dispersion) and when light is incident at high angles. Both of these conditions were met during the micreplication process, allowing for at least partial cure of the coating solution through the ESR as it wrapped around the cylindrical microreplication tool.

The UV-LED bank used 8 rows with 16 LEDs (Nichia NCCU001, peak wavelength=385 nm) per row. The LEDs were configured on 4 circuit boards that were positioned such that the face of each circuit board was mounted at a tangent to the surface of the microreplication tool roll and the distance of the LEDs can be adjusted to distance of between 0.5 and 1.5 inches. The LEDs were driven 16 parallel strings of 8 LEDs in series. The UV-LED bank was controlled by adjusting the device current. For the experiments described herein the current was set to approximately 5.6 amps at 35.4 V with the distance of the LEDs to the microreplication tooling being between 0.5 and 1.0 inches. The irradiance was uncalibrated. The coating solution was cured with the solvent present as the film and tool rotated past the banks of UV LEDs (the coated film being oriented such that the coating was disposed between the tool and the film), forming micro-replicated solvent-saturated nanovoided structure arrays corresponding to the negative or 3-dimensional inverse or complement of the tool structure.

The structured film separated from the tool and was collected on a take-up roll. In some cases, the micro-structured coating was further cured (post-process curing) by UV radiation to improve the mechanical characteristics of the coating. The post-process curing was accomplished using a Fusion Systems Model 1300P (Gaithersburg Md.) fitted with an H-bulb. The UV chamber was nitrogen-inerted to approximately 50 ppm oxygen.

TABLE 3
Microstructured ultra low index materials

| | Sub- | Feature | | |
|---|---|---|---|---|
| Structure Name | strate | Height | Pitch | Properties |
| cylindrical lens 1 | PET | 5.5 μm | 29.5 μm | convex linear array, |
| | | | | 22.6 μm radius |
| cylindrical lens 2 | PET | 5.1 μm | 45.5 μm | concave linear array, |
| | | | | 53.0 μm radius |
| linear prism 1 | PET | 25.6 μm | 29.5 μm | linear array, |
| | | | | 60° included angle |
| linear prism 2 | PET | 2.9 μm | 81.6 μm | linear array, |
| | | | | 172° included angle |
| linear prism 2 | 3M | 2.9 μm | 81.6 μm | linear array, |
| | ESR | | | 172° included angle |
| Microlens array | PET | 11 μm | ~40 μm | concave hexagonal array, |

### 5. Lamination of Transfer Adhesive to Microstructured Nanovoided Layer

Samples of microstructured nanovoided layers were then laminated with a layer of transfer adhesive (Soken 1885, Soken Chemical & Engineering Co., Ltd, Japan, cast as a 1 mil thick film between two liners) using light pressure and a hand roller. This produced articles that had an adhesive-sealed microreplicated nanovoided layer in which the surface of the adhesive had a structure imparted to it by the microreplicated nanovoided layer (see surface 632 of FIG. 6).

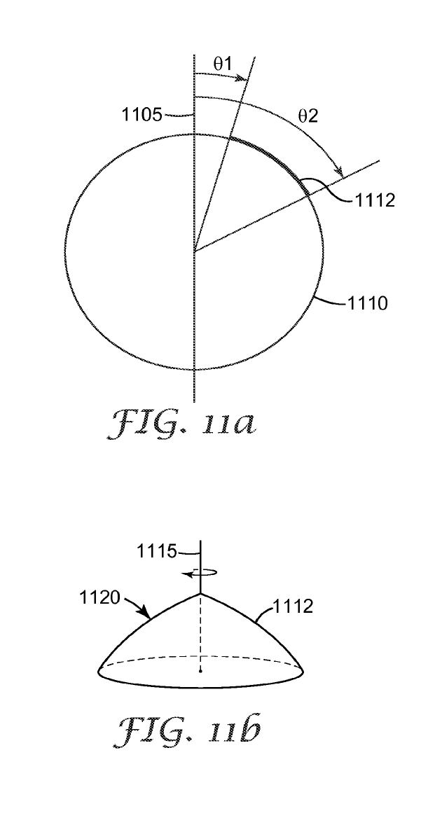

Under more controlled lamination conditions heat and pressure can aid in achieving good lamination of transfer adhesives into the microreplicated nanovoided layer. The hexagonal microlens array film with shallow lens features (11 micron height, ˜40 micron pitch) was laminated with a 1 mil Soken 1885 adhesive. The adhesive was disposed between two release liners. The lamination of the film at room temperature using a GBC 35 Laminator (speed set to 5, nip pressure 1/32″/mm, roller temperature 72° F.) yielded a laminated film where there were still air bubbles trapped between the Soken transfer adhesive and the nanovoided layer, shown in FIG. 10a. Heating the rolls of the laminator to a temperature of 160° F. or greater and relaminating the same films (speed set to 5, nip pressure 1/32″/mm) eliminated the air bubbles from the original lamination. The optical micrograph of FIG. 10b shows the film from FIG. 10a, where half of the film was laminated again; the boundary 1010 in the figure separates the portion of the film 1012 as originally laminated from the portion 1014 that was re-laminated at high temperature. FIG. 10c shows that lamination of the Soken transfer adhesive to the microreplicated nanovoide layer at 160° F. yields an intimate contact between the adhesive and the nanovoided layer (GBC 35 laminator speed set to 5, nip pressure set to 1/32″/mm). We thus see that proper control of temperature and pressure can allow for rapid roll to roll lamination backfilling of the microreplicated, nanoporous films.

### 6. Solventborne Backfills of Microstructured Nanovoided Layer

Three solventbome formulations were used to backfill the microstructured ultra low index materials.

High viscosity resin #1: 10 % Wt solid of 99% polyvinyl butyral acrylate (Butvar B98) and 1% Irgacure 814 in MEK was used to overcoat a microstructured nanovoided layer sample comprising inverted cylindrical lenses, dried in oven at 100° C. for 1 minute, and then put through a UV processor (Fusion UV-Light Hammer 6 with H bulb, RPC Industries Model Number 16P1/LH Serial Number 1098) at 30 feet per minute under nitrogen for 2 passes.

High viscosity resin #2: 10 % Wt solid of polyvinyl butyral (Butyvar B76) in IPA was used to overcoat a microstructured nanovoided layer sample comprising inverted cylindrical lenses using coating rod #24 and dried in oven at 100° C. for 1 minute.

Optical Clear Adhesive: 27% Wt solid of PSA (IOAA/AA=93/7 wt/wt) in EtOAc/Heptane (60:40 wt/wt) was used to overcoat a microstructured nanovoided layer sample comprising inverted cylindrical lenses using coating rod #24 and dried in an oven at 100° C. for 1 minute, and then was laminated to a PET substrate using light pressure and a hand roller.

### Examples Section 2

### 7. Reactive Nanoparticles

### Reactive Nanoparticle Dispersion 1

### Surface Modification of IPA-ST-UP (A174-Treated IPA-ST-UP)

In a 2 liter three-neck flask, equipped with a condenser and a thermometer, 960 grams of IPA-ST-UP organosilica elongated particles (available from Nissan Chemical Inc., Houston, Tex.), 19.2 grams of deionized water, and 350 grams of 1-methoxy-2-propanol were mixed under rapid stirring. The elongated particles had a diameter in a range from about 9 nm to about 15 nm and a length in a range of about 40 nm to about 100 nm. The particles were dispersed in a 15.2 % wt IPA. Next, 22.8 grams of Silquest A-174 silane (available from GE Advanced Materials, Wilton, Conn.) was added to the flask. The resulting mixture was stirred for 30 minutes.

The mixture was kept at 81 degrees centigrade for 16 hours, and then allowed to cool to room temperature. Next, about 950 grams of solvent were removed from the solution using a rotary evaporator with a 40 degrees centigrade water-bath, resulting in a 40.0% wt A-174-modified elongated silica clear dispersion in 1-methoxy-2-propanol.

### Reactive Nanoparticle Dispersion 2

### Surface Modification of IPA-ST-UP (A174-Treated IPA-ST-UP)

A 2000 ml 3-neck flask equipped with a stir bar, stir plate, condenser, heating mantle and thermocouple/temperature controller was charged with 1000 grams Nissan 1PA-ST-UP (a 16 wt % solids dispersion of colloidal silica in Isopropanol, Nissan Chemical America Corporation). To this dispersion, 307.5 grams of 1-methoxy-2-propanol was added with stirring. Next 1.63 grams of Dimethylaminoethylmethacrylate (TCI America) and 25.06 grams of 97% 3-(Methacryloxypropyl)trimethoxysilane (Alfa Aesar Stock # A17714) was added to a 100 ml poly beaker. The

Dimethylaminoethylmethacrylate/3-(Methacryloxypropyl)trimethoxysilane premix was added to the batch with stirring. The beaker containing the premix was rinsed with aliquots of 1-methoxy-2-propanol totaling 100 grams. The rinses were added to the batch. At this point the batch was a nearly-clear, colorless, low-viscosity dispersion. The batch was heated to 81 deg C and held for approximately 16 hours. The batch was cooled to room temperature and transferred to a 2000 ml 1-neck flask. The reaction flask was rinsed with 100 grams of 1-methoxy-2-propanol and the rinse was added to the batch. The batch was concentrated by vacuum distillation to result in a slightly viscosity, nearly clear dispersion with 43.5 wt % solids.

### Nanoparticle Resin Blend 1

### A174-Treated IPA-ST-UP/SR444 Blend

A 2000 ml 1-neck flask was charged with 139.2 grams of SR444 (Sartomer Company, Warrington, Pa.) and 139 grams of 1-methoxy-2-propanol. The flask was swirled to disperse the SR444. To this mixture, 400 grams of a nanoparticle dispersion 2, A 174 treated IPA-ST-UP nanoparticles (43.5 wt % solids in 1-methoxy-2-propanol) was added. The resultant mixture is a slightly viscous, slightly yellow-tinted dispersion. The batch was concentrated by vacuum distillation to result in a nearly clear, viscous dispersion with 70.4 wt % solids.

### 8. Coating Formulations

### Formulation 1

A coating solution was made by first dissolving CN 9893 (Available from Sartomer, Sartomer Company, Inc. 502 Thomas Jones Way, Exton, Pa. 19341, a Difunctional aliphatic urethane oligomer) in ethyl acetate (40% solids by weight) under ultrasonic agitation. To the solution was added the A 174-Treated IPA-ST-UP/SR444 blend, the photoinitiators and Tegorad 2250. The solution was stirred to form a homogenous solution. The coating formulation is provided in Table 4 and was 65.8% solids by weight in solvent.

TABLE 4
Coating solution formulation

| Materials | % Solid | Amount (g) |
|---|---|---|
| A-174 UP Silica/SR444 Blend | 70.40% | 145.2 |
| in 1-methoxy-2-propanol | | |
| CN9893 in ethyl acetate | 40.00% | 28.6 |
| Irgacure 184 | 100.00% | 0.70 |
| Irgacure 819 | 100.00% | 0.14 |
| Tego ®Rad 2250 | 100.00% | 1.14 |
| Total | | 175.78 |

### Formulation 2

To a small amber glass jar was added 20.0 g of Formulation 1, 13.14 g of solids in 3.86 g of solvent. To the jar was added 0.5 g of ethyl acetate and the solution was stirred until homogeneous. The resulting formulation was 62.6% solids.

### Formulation 3

To a small amber glass jar was added 20.0 g of Formulation 1, 13.14 g of solids in 3.86 g of solvent. To the jar was added 1.0 g of ethyl acetate and the solution was stirred until homogeneous. The resulting formulation was 59.7% solids.

### Formulation 4

To a small amber glass jar was added 20.0 g of Formulation 1, 13.14 g of solids in 3.86 g of solvent. To the jar was added 1.5 g of ethyl acetate and the solution was stirred until homogeneous. The resulting formulation was 57.1% solids.

### Formulation 5

To a small amber glass jar was added 20.0 g of Formulation 1, 13.14 g of solids in 3.86 g of solvent. To the jar was added 2.0 g of ethyl acetate and the solution was stirred until homogeneous. The resulting formulation was 54.8% solids.

### Formulation 6

To a small amber glass jar was added 20.0 g of Formulation 1, 13.14 g of solids in 3.86 g of solvent. To the jar was added 2.5 g of ethyl acetate and the solution was stirred until homogeneous. The resulting formulation was 52.6% solids.

### Formulation 7

To a small amber glass jar was added 20.0 g of Formulation 1, 13.14 g of solids in 3.86 g of solvent. To the jar was added 2.5 g of ethyl acetate and the solution was stirred until homogeneous. The resulting formulation was 50.6% solids.

### Formulation 8

A coating solution was made by first dissolving CN 9893 (Available from Sartomer, Sartomer Company, Inc. 502 Thomas Jones Way, Exton, Pa. 19341, a Difunctional aliphatic urethane oligomer.) in ethyl acetate (29.2% solids by weight) under ultrasonic agitation. To the solution was added the nanoparticle dispersion 1, A174-Treated IPA-ST-UP, the photoinitiators and Tegorad 2250. The solution was stirred to form a homogenous solution. The coating formulation is provided in Table 5 and is 50.7% solids by weight in solvent.

TABLE 5
Coating solution formulation

| Materials | % Solid | Amount (g) |
|---|---|---|
| A-174 UP Silica in | 40% | 131.25 |
| 1-methoxy-2-propanol | | |
| SR444 | 100% | 42.0 |
| CN9893 in ethyl acetate | 29.2% | 36.0 |
| Irgacure 184 | 100.00% | 0.288 |
| Irgacure 819 | 100.00% | 0.80 |
| Tego ®Rad 2250 | 100.00% | 1.0 |
| Total | | 211.33 |

### Formulation 9

To a small amber glass jar was added 20.0 g of Formulation R. To the jar was added 0.5 g of ethyl acetate and the solution was stirred until homogeneous. The resulting formulation was 49.5% solids.

### Formulation 10

To a small amber glass jar was added 20.0 g of Formulation 8. To the jar was added 1.0 g of ethyl acetate and the solution was stirred until homogeneous. The resulting formulation was 48.3% solids.

### Formulation 11

To a small amber glass jar was added 20.0 g of Formulation 8. To the jar was added 1.5 g of ethyl acetate and the solution was stirred until homogeneous. The resulting formulation was 47.2% solids.

### Formulation 12

To a small amber glass jar was added 20.0 g of Formulation 8. To the jar was added 2.0 g of ethyl acetate and the solution was stirred until homogeneous. The resulting formulation was 46.1% solids.

### Formulation 13

To a small amber glass jar was added 20.0 g of Formulation 8. To the jar was added 2.5 g of ethyl acetate and the solution was stirred until homogeneous. The resulting formulation was 45.0% solids.

### Formulation 14

To a small amber glass jar was added 20.0 g of Formulation 8. To the jar was added 5.0 g of ethyl acetate and the solution was stirred until homogeneous. The resulting formulation was 40.6% solids.

### Formulation 15

To a small amber glass jar was added 20.0 g of Formulation 8. To the jar was added 10.0 g of ethyl acetate and the solution was stirred until homogeneous. The resulting formulation was 33.8% solids.

### 9. Microreplication Tools

The microreplication tools used for the experimental examples were all film replicates from metallic cylindrical tool patterns. The tools used for making the film tools were modified diamond turned metallic cylindrical tool patterns that were cut into the copper surface of the tool using a precision diamond turning machine. The resulting copper cylinders with precision cut features were nickel plated and coated with PA11-4. Plating and coating process of the copper master cylinder is a common practice used to promote release of cured resin during the microreplication process.

The film replicates were made using an acrylate resin comprising acrylate monomers and a photoinitiator that was cast onto a PET support film (2-5 mil thicknesses) and then cured against a precision cylindrical tool using ultraviolet light. The surface of the resulting structured film was coated with a silane release agent (tetramethylsilane) using a plasma-enhanced chemical vapor deposition (PECVD) process. The release treatment consisted of first an oxygen plasma treatment of the film with 500 ccm O₂ at 200 W for 20 seconds, followed by a tetramethylsilane (TMS) plasma treatment with 200 ccm TMS at 150 W for 90 seconds. The surface-treated structured film was then used as a tool by wrapping and securing a piece of the film, structured side out, to the surface of a casting roll.

TABLE 6
Microreplication tools used in the fabrication of
structured ultra low index nanovoided materials

| | | Feature | | |
|---|---|---|---|---|
| Tool Name | Type | Height | Pitch | Properties |
| BEF II 90/50 | film | 25 μm | 50 μm | linear prism array, |
| | | | | 90° included angle |
| Bullet microlens | film | 25 μm | ~50 μm | convex hexagonal array of |
| array | | | | Bullet shaped lenses |

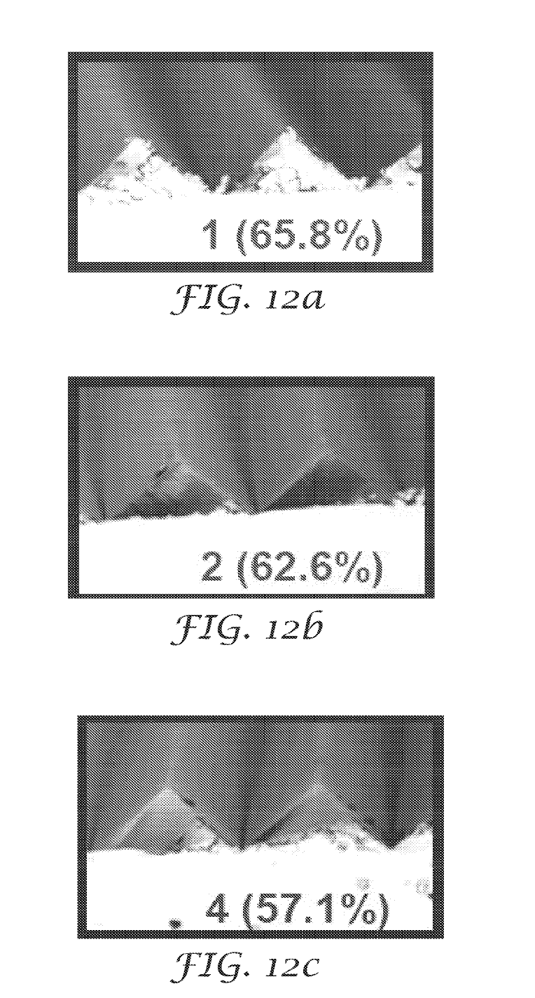

BEF II 90/50 is commercially available from 3M Company. The Bullet microlens array film was made by using a bullet-shaped microreplication tooling made an excimer laser machining process as described in U.S. Pat. No. 6,285,001 (Fleming et al.). The resulting pattern was translated into a copper roll having an inverted bullet shape, where the bullet features are arranged in a closely packed hexagonal pattern with 50 μm pitch, and the shape of the bullet is given by a surface of revolution generated by rotating a segment of a circle about an axis, explained more fully by reference to FIGS. 11a and 11b. The curved segment 1112 used to define the bullet-shapes is the segment of a circle 1110 lying between an angle θ1 and an angle θ2 as measured from an axis 1105 in the plane of the circle that passes through the center of the circle. The segment 1112 is then rotated about an axis 1115, the axis 1115 being parallel to axis 1105 but intersecting the endpoint of the curved segment, so as to generate the bullet-shaped surface of revolution 1120. For the present examples, the bullet shapes were defined by θ1=25 degrees and θ2=65 degrees. The copper roll was then used as the replication master to make the Bullet microlens array film tool described in Table 6 by a continuous cast and cure microreplication process using a UV curable urethane containing acrylatc resin (75% PHOTOMER 6210 available from Cognis and 25% 1,6-hexanedioldiacrylate available from Aldrich Chemical Co.) and a photoinitiator (1% wt Darocur 1173, Ciba Specialty Chemicals) and casting the structures onto a 5 mil primed PET substrate (DuPont 618 PET Film).

### 10. Nanovoided Layer Microreplication

A film microreplication apparatus was employed to create microstructured nanovoided structures on a continuous film substrate. The apparatus included: a needle die and syringe pump for applying the coating solution; a cylindrical microreplication tool; a rubber nip roll against the tool; a series of UV-LED arrays arranged around the surface of the microreplication tool; and a web handling system to supply, tension, and take up the continuous film. The apparatus was configured to control a number of coating parameters manually including tool temperature, tool rotation, web speed, rubber nip rolUtool pressure, coating solution flow rate, and UV-LED irradiance. An example process is illustrated in FIG. 1.

The coating solution (see above) was applied to a 3 mil PET film (DuPont Melinex film primed on both sides) adjacent to the nip formed between the tool and the film. The flow rate of the solution was adjusted to about 0.25 ml/min and the web speed was set to ft/min so that a continuous, rolling bank of solution was maintained at the nip.

The UV-LED bank used 8 rows with 16 LEDs (Nichia NCCU001, peak wavelength=385 nm) per row. The LEDs were configured on 4 circuit boards that were positioned such that the face of each circuit board was mounted at a tangent to the surface of the microreplication tool roll and the distance of the LEDs can be adjusted to distance of between 0.5 and 1.5 inches. The LEDs were driven 16 parallel strings of 8 LEDs in series. The UV-LED bank was controlled by adjusting the device current. For the experiments described herein the current was set to approximately 5.6 amps at 35.4 V with a distance of the LEDs to the micrreplication tooling being between 0.5 and 1.0 inches.

The irradiance was uncalibrated. The coating solution was cured with the solvent present as the film and tool rotated past the banks of UV LEDs, forming micro-replicated solvent-saturated nanovoided structure arrays corresponding to the negative or 3-dimensional inverse or complement of the tool structure.

The structured film separated from the tool and was collected on a take-up roll. In some cases, the micro-structured coating was further cured (post-process curing) by UV radiation to improve the mechanical characteristics of the coating. The post-process curing was accomplished using a Fusion Systems Model 1300P (Gaithersburg, Md.) fitted with an II-bulb. The UV chamber was nitrogen-inerted to approximately 50 ppm oxygen.

### BEF 11 90/50 Tool

Coating Formulations 1-15 were replicated using the apparatus and conditions described above from the 90/50 BEF II film tool which was treated for release via plasma silane deposition. The tool had linear prisms which are 25 microns in height with a 50 micron pitch and 90 degree included angle. The replication conditions are described in Tables 7 and 8.

TABLE 7
Microreplication conditions and results
for solvent dilutions of Formulation 1

| | | Refrac- | |
|---|---|---|---|
| Formulation | Line | tive | |
| (% Solids) | Speed | Index | Comments |
| 1 (65.8%) | 3 | 1.317 | Good replication, no cracking |
| 2 (62.6%) | 3 | 1.300 | Good replication, no cracking |
| 3 (59.7%) | 3 | 1.297 | Good replication, no cracking |
| 4 (57.1%) | 3 | 1.282 | Good replication, no cracking |
| 5 (54.8%) | 3 | 1.273 | Good replication, no cracking |
| 6 (52.6%) | 3 | 1.261 | Good replication, little to no cracking |
| 7 (50.5%) | 3 | 1.252 | Good replication, little to no cracking |

TABLE 8
Microreplication conditions and results
for solvent dilutions of Formulation 8

| | | Refrac- | |
|---|---|---|---|
| Formulation | Line | tive | |
| (% Solids) | Speed | Index | Comments |
| 8 (50.7%) | 3 | 1.235 | Good replication, little to no cracking |
| 9 (49.5%) | 3 | 1.230 | Good replication, little to no cracking |
| 10 (48.3%) | 3 | 1.226 | Fair replication, little cracking in |
| | | | btwn prisms |
| 11 (47.2%) | 3 | 1.225 | Fair replication, some cracking in btwn |
| | | | prisms |
| 12 (46.1%) | 3 | 1.221 | Fair replication, some cracking in btwn |
| | | | prisms |
| 13 (45.0%) | 3 | 1.208 | Fair replication, some cracking in btwn |
| | | | prisms |
| 14 (40.6%) | 3 | 1.201 | Poor replication, cracking in btwn |
| | | | prisms |
| 15 (33.8%) | 3 | 1.199 | Poor replication, cracking in btwn |
| | | | prisms |

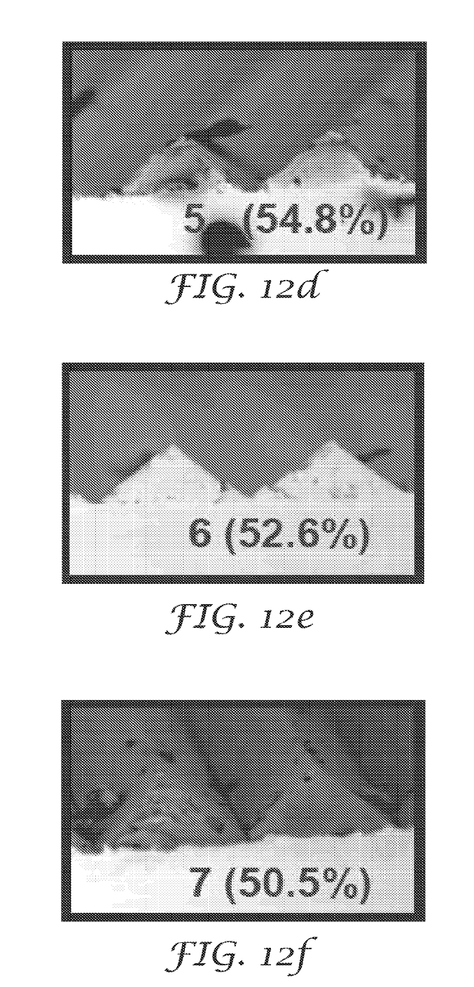

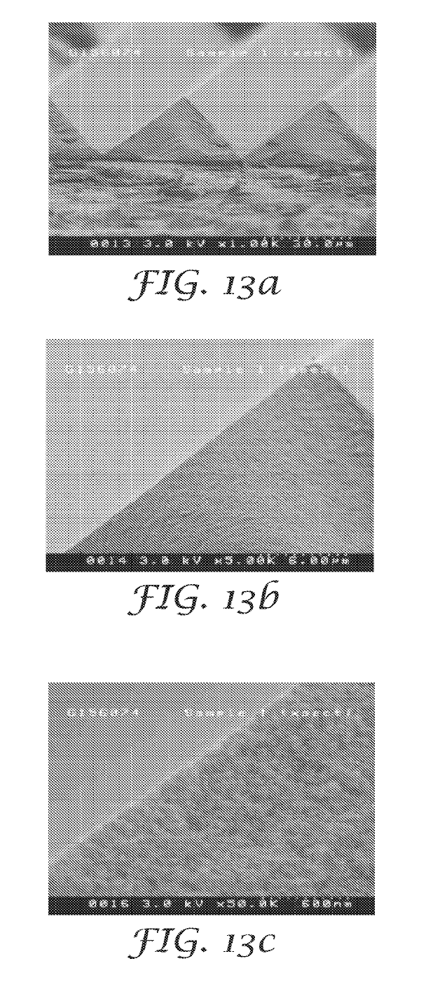

SEM images of the replicated nanovoided complements of the BEF II 90/50 tool are shown in FIGS. 12, 13, and 14. FIGS. 12a through 12f show low resolution SEM images of the replicated samples in the concentration range from 50.5% to 65.8% solids (Formulations 1-8) as labeled in the figures. As can be seen in the images the replication fidelity of these samples is very good in terms of replication of the film tool microstructure. FIGS. 13a-c show high resolution SEM micrographs of the nanovoided complement made using Formulation 5 (54.8% solids). FIGS. 13a and 13b show that the nanovoided complement has the correct geometry matching the inverse structure of the BEF II 90/50 film tool. FIG. 13c shows a close up image showing the nanoporous nature of the structure.

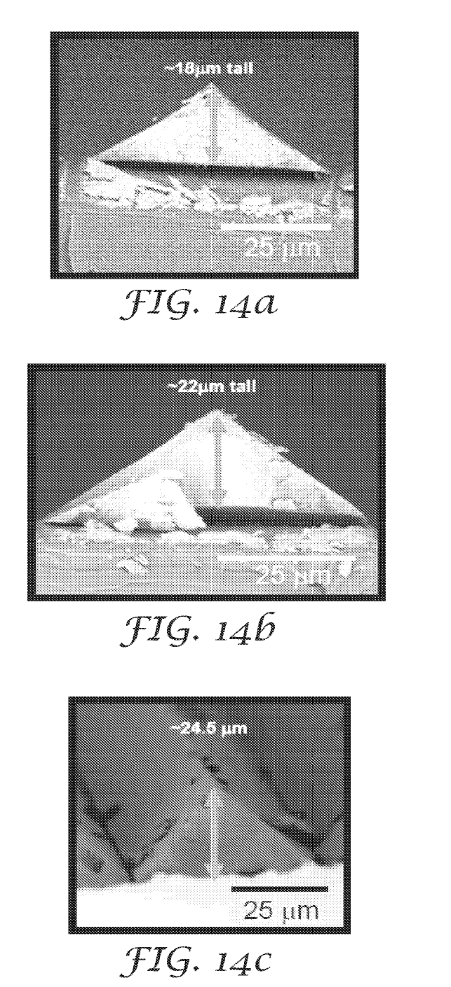

FIGS. 14a-c show SEM images for samples made from Formulations 5, 14, and 15, which were 33.8% (FIG. 14a), 40.6% (FIGS. 14b), and 54.8% (FIG. 14c) solids respectively. All of the formulations produce replicated nanovoided structures, but the samples made using lower concentration formulations (FIGS. 14a and 14b) do not replicate the large prism structures as accurately as the higher concentration formulation (FIG. 14c), due to shrinkage and/or collapse of the cured structure made in the process. The prism structures shown in FIGS. 14a and 14b are ˜18 and ˜22 microns respectively when they should be ˜25 microns in height. The cracking between prism noted in Table 8 occurs at the base of the nanovoided layer at the substrate interface in between prisms. In certain circumstances, it may be desirable for the prism features to separate from one another on the substrate. In order to replicate larger microstructures using low concentration formulations, in the range of 30-45% solids, compensation of the microstructure geometry on the tool may be used to account for material shrinkage, so that the desired feature shape can be successfully made.

Our studies of aspects of the microstructured surface of the nanovoided layer and aspects of the composition of the nanovoided layer (and the composition of the coating solution that is a precursor to the nanovoided material) lead us to define certain desirable relationships associated with a reduced amount of shrinkage or of other distortion of the microstructured surface. In one such relationship, the microstructured surface is characterized by a structure height (see e.g. dimension S4 in FIGS. 3b, 3d) of at least 15 microns and an aspect ratio (structure height divided by structure pitch) greater than 0.3, and: the nanovoided layer has a void volume fraction in a range from 30% to 55%; and/or the nanovoided layer has a refractive index in a range from 1.21 to 1.35, or 1.21 to 1.32; and/or the coating solution precursor to the nanovoided layer has a wt % solids in a range from 45% to 70%, or from 50% to 70%.

### Bullet Microarray Film Tool

Coating Formulations 5, 7 and 14 were also used to replicate using the same conditions described above from the Bullet microarray film tool which had been treated for release via plasma silane deposition. The tool had a hexganol array of convex bullet-shaped protrusions which were approximately 25 microns in height with a pitch of approximately 50 microns. The shape of the features is shown in FIG. 11. The replication conditions are described in Table 9.

TABLE 9
Microreplication conditions and results
for Bullet microarray film tool

| Formulation | Line | |
|---|---|---|
| (% Solids) | Speed | Comments |
| 5 (54.5%) | 3 | Good replication, no cracking btwn features |
| 7 (50.5%) | 3 | Good replication, little to no cracking |
| 14 (40.6%) | 3 | Fair replication, some cracking btwn features |

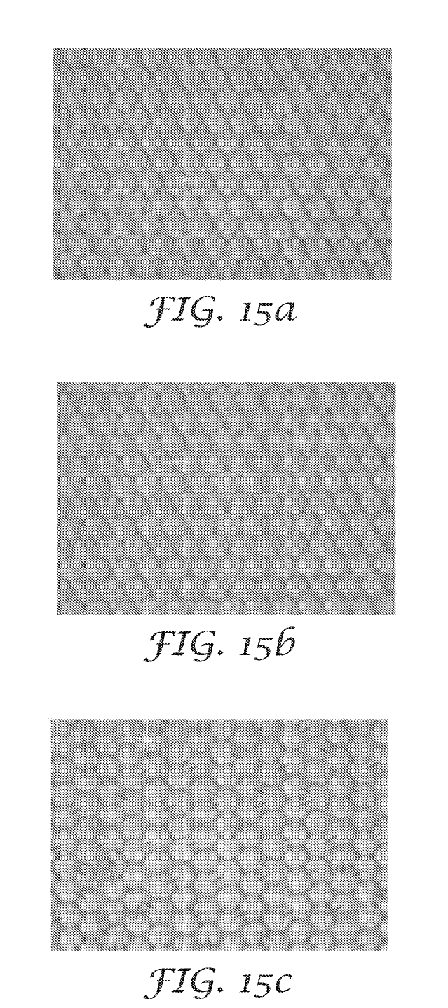

FIGS. 15a-c show SEM images for samples made from Formulations 5, 7, and 14 which were 54.5% (FIG. 15a), 50.5% (FIGS. 15b) and 40.6% (FIG. 15c) solids respectively. All three concentrations of the formulations produced replicated nanovoided structures.

The samples made at higher concentrations produced good replication with no defects in the complement structure (FIGS. 15a and 15b). The replicate made using the 40.6% solids formulation replicated the structure well, but the features showed some cracking defects between the prism structures (see FIG. 15c).

### 11. Lamination of Transfer Adhesive to Microstructured Nanovoided Layer

A 3-mil (0.003 inch) thick layer of transfer adhesive was made using the following procedure. 1000 g of Soken 2094 adhesive solution (25% solids in solvent) was added to a 2 Liter glass jar along with 2.7 g of E-AX crosslinker. The mixture was agitated by rolling the solution for 4 hours. The solution was then coated onto a T50 release liner using a gap height of the coater at 18 mils. The coating was dried in a constant temperature oven at 80° C. for 10 minutes to remove all solvent then another release liner was laminated to the exposed face of the PSA. The resulting pressure sensitive adhesive film had an approximate thickness of 3 mils. Samples of the microstructured nanovoided layer made using Formulation 5 were laminated with a layer of the above described 3 mil transfer adhesive (Soken 2094, Soken Chemical & Engineering Co., Ltd, Japan) using a GBC 35 Laminator with heated rollers. The Soken 2094 transfer adhesive was then laminated by removing one of the release liners from the adhesive and it was laminated to the surface of the nanovoidcd microstructured film. The laminator speed was set to 2, the rollers were set to 1/32″/mm, and the roll temperature was set at 160° F. This produced an article that had an adhesive-sealed microreplicated nanovoided layer in which the interior surface of the adhesive had a structure imparted to it by the microreplicated nanovoided layer (See surface 632, FIG. 6). Inspection of the sample under an optical microscope at 40× magnification showed that the pressure sensitive adhesive was in intimate contact with the surface of the nanovoided layer.

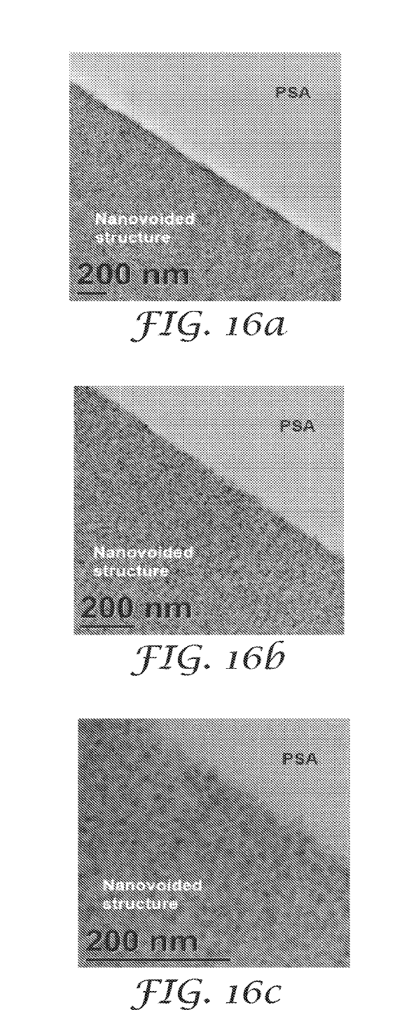

The interface of the laminated sample was characterized by Transmission Electron Microscopy on a Hitachi H-9000 TEM at 300 kV. Samples were prepared by placing the laminated PSA sample into a freezer, “houses” (blocks) were then cut from the sample and the liners removed. The samples were embedded in ScotchCast 5 (3M Company) and cut with ultramicrotomy. The samples were then Cut using wet cryo-conditions of −43° C. and floated onto DMSO/Water at 60/40 ratio. The samples were cut to a thickness of 95 nm. The samples were then placed onto a TEM grid for analysis. FIGS. 16a-c show TEM images of the PSA nanovoidcd layer interface of one of the samples at various magnifications. FIGS. 16a and 16b show that the replicated nanovoided layer has an accurate complementary shape to the BEF II 90/50 film tool, 90 degree included angle for the prism and flat prism faces. FIG. 16c shows that the Soken 2094 PSA is in intimate contact with the surface of the nanovoided layer and the PSA takes on the structure of the nanovoided surface and has penetrated into the nanovided layer at least to the void volume depth of the voids at the surface of the replicated structure.

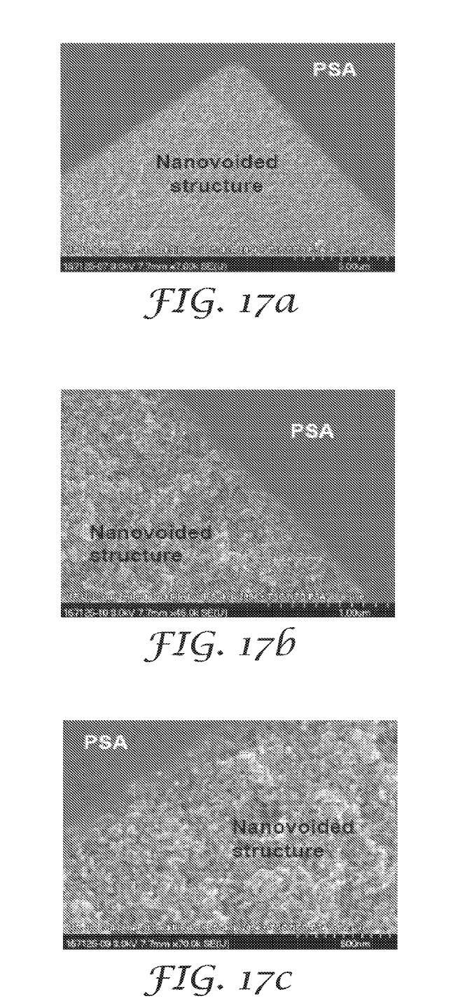

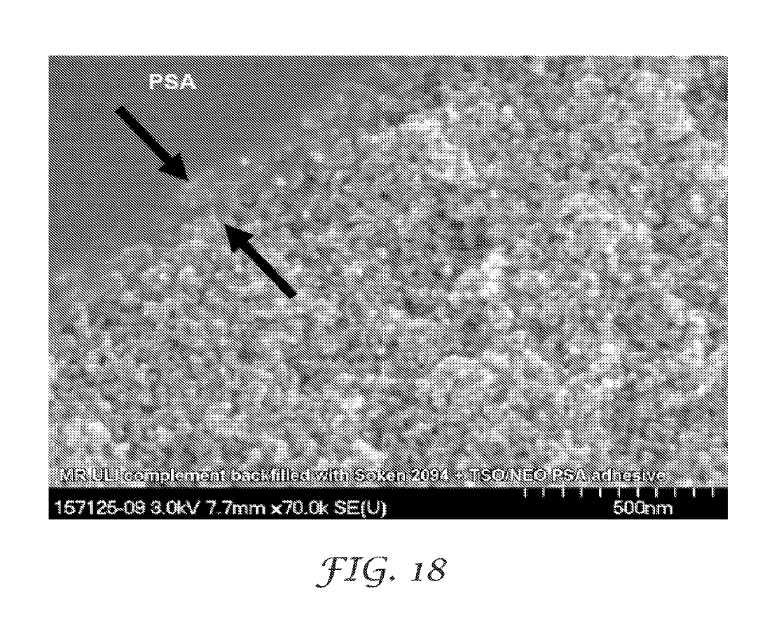

The interface was also characterized by Scanning Electron Microscopy using a Hitachi S-4700 Field Emission Scanning Electron Microscope. A sample was prepared by first cooling a piece of the sample and a rounded scalpel blade in liquid nitrogen. The sample was cut under liquid nitrogen with the sample oriented such that the cut would reveal the pyramid structure of the linear prisms in cross-section. The cross-sections were mounted onto an SEM stub and a thin layer of Au/Pd was vapor deposited to make the samples conductive. Areas of the cross-section were chosen for examination where the prism shape was correctly oriented and no debris from the sample preparation was present. Images were taken at multiple magnifications (7000×, 45,000×, and 70,000×) as shown in FIGS. 17a, 17b, and 17c. FIG. 18 shows an enlarged view of the nanovoid layer/PSA interface of FIG. 17c. The region identified in FIG. 18 between the arrows is a region in which the PSA has penetrated into the surface of the nanovoided layer to a depth of approximately 150 nm.

### Examples Section 3

### 12. Reactive Nanoparticles

### A-174 Treated Silica Nanoparticles

In a 2 liter three-neck flask, equipped with a condenser and a thermometer, 960 grams of IPA-ST-UP organosilica elongated particles (available from Nissan Chemical Inc., Houston, Tex.), 19.2 grams of deionized water, and 350 grams of 1-methoxy-2-propanol were mixed under rapid stirring. The elongated particles had a diameter in a range from about 9 nm to about 15 nm and a length in a range of about 40 nm to about 100 nm. The particles were dispersed in a 15.2% wt IPA. Next, 22.8 grams of Silquest A-174 silane (available from GE Advanced Materials, Wilton, Conn.) was added to the flask. The resulting mixture was stirred for 30 minutes.

The mixture was kept at 81° C. for 16 hours. Next, the solution was allowed to cool down to room temperature. Next, about 950 grams of the solvent in the solution were removed using a rotary evaporator under a 40° C. water-bath, resulting in a 40 wt % A-174-modified elongated silica clear dispersion in 1-methoxy-2-propanol.

### 13. Coating Formulation

To an amber glass jar was added 131.25 g of a 40 wt % solution of A-174 treated silica nanoparticles IPA-ST-UP in 1-methoxey-2-propanol. To the jar was also added 42 g of Sartomer SR 444 and 10.5 g of Sartomer CN 9893 (both available from Sartomer Company, Exton, Pa.), 0.2875 g of Irgacure 184, 0.8 g of Irgacure 819 (both available from Ciba Specialty Chemicals Company, High Point, N.C.), 1 g of TEGO® Rad 2250 (available from Evonik Tego Chemie GmbH, Essen, Germany) and 25.5 grams of ethyl acetate. The contents of the formulation were mixed thoroughly giving a UV curable ULT resin with 50.5% solids by weight.

### 14. Microreplication Tool

### 400 nm 1D Structures

The microreplication tool used for the experimental example was a film replicate from a metallic cylindrical tool pattern. The tool used for making the 400 nm “sawtooth” 1D structured film tool was modified diamond turned metallic cylindrical tool pattern that was cut in to the copper surface of the tool using a precision diamond turning machine. The resulting copper cylinder with precision cut features was nickel plated and coated with PA11-4. The plating and coating process of the copper master cylinder is a common practice used to promote release of cured resin during the microreplication process.

The film replicate was made using an acrylate resin comprising acrylate monomers and a photoinitiator that was cast onto a PET support film (5 mil thicknesses) and then cured against a precision cylindrical tool using ultraviolet light. The surface of the resulting structured film was coated with a silane release agent (tetramethylsilanc) using a plasma-enhanced chemical vapor deposition (PECVD) process. The release treatment consisted of an oxygen plasma treatment of the film with 500 ccm O₂ at 200 W for 20 seconds followed by a tetramethylsilane (TMS) plasma treatment with 200 ccm TMS at 150 W for 90 seconds. The surface-treated structured film was then used as a tool by wrapping and securing a piece of the film, structured side out, to the surface of a casting roll.

### 15. Nanovoided Layer Microreplication

A film microreplication apparatus was employed to create microstructured nanovoided structures on a continuous film substrate. The apparatus included: a needle die and syringe pump for applying the coating solution; a cylindrical microreplication tool; a rubber nip roll against the tool; a series of UV-LED arrays arranged around the surface of the microreplication tool; and a web handling system to supply, tension, and take up the continuous film. The apparatus was configured to control a number of coating parameters manually including tool temperature, tool rotation, web speed, rubber nip roll/tool pressure, coating solution flow rate, and UV-LED irradiance. An example process is illustrated in FIG. 1.

The coating solution (see above) was applied to a 3 mil PET film (DuPont Melinex film primed on both sides) adjacent to the nip formed between the tool and the film. The flow rate of the solution was adjusted to about 0.25 ml/min and the web speed was set to 1 ft/min so that a continuous, rolling bank of solution was maintained at the nip.

The UV-LED bank used 8 rows with 16 LEDs (Nichia NCCU001, peak wavelength=385 nm) per row. The LEDs were configured on 4 circuit boards that were positioned such that the face of each circuit board was mounted at a tangent to the surface of the microreplication tool roll and the distance of the LEDs can be adjusted to distance of between 0.5 and 1.5 inches. The LEDs were driven 16 parallel strings of 8 LEDs in series. The UV-LED bank was controlled by adjusting the device current. For the experiments described herein the current was set to approximately 5.6 amps at 35.5 V with a distance of the LEDs to the micrreplication tooling being between 0.5 and 1.0 inches.

The irradiance was uncalibrated. The coating solution was cured with the solvent present as the film and tool rotated past the banks of UV LEDs, forming micro-replicated solvent-saturated structure arrays corresponding to the negative or 3-dimensional inverse or complement of the tool structure. The structured film separated from the tool and was collected on a take-up roll. In some cases, the micro-structured coating was further cured (post-process curing) by UV radiation to improve the mechanical characteristics of the coating. The post-process curing was accomplished using a Fusion Systems Model 1300P (Gaithersburg Md.) fitted with an H-bulb. The UV chamber was nitrogen-inerted to approximately 50 ppm oxygen. The refractive index of the nanoreplicated ULI layer was measured using a Metricon Model 2010 Prism Coupler (available from Metricon Corporation, Pennington, N.J.) and was found to be about 1.27.

### 16. Inorganic Backfill of the Nanostructured Nanovoided Layer

The nanoreplicated ULI layer on PET was backfilled and roughly planarized with a 1000 nm thick layer of silicon nitride by plasma-enhanced chemical vapor deposition (PECVD, Model PlasmaLab™ System100 available form Oxford Instruments, Yatton, UK). The parameters used in the PECVD process are described in Table 10.

TABLE 10
Plasma-enhanced CVD process conditions

| Reactant/Condition: | Value: | |
|---|---|---|
| SiH4 | 400 | sccm |
| NH3 | 20 | sccm |
| N2 | 600 | sccm |
| Pressure | 650 | mTorr |
| Temperature | 100° | C. |
| High frequency (HF) power | 20 | W |
| Low frequency (LF) power | 20 | W |

The refractive index of the silicon nitride layer was measured using a Metricon Model 2010 Prism Coupler (available from Metricon Corporation, Pennington, N.J.) and was found to be 1.78. The refractive index contrast or difference between the ULI and silicon nitride backfill in the nanostructured layer was about 0.5.

Various modifications and alterations of this invention will be apparent to those skilled in the art without departing from the scope and spirit of this invention, and it should be understood that this invention is not limited to the illustrative embodiments set forth herein. All U.S. patents, published and unpublished patent applications, and other patent and non-patent documents referred to herein are incorporated by reference, to the extent they are not inconsistent with the foregoing disclosure.

Unless otherwise indicated, all numbers expressing feature sizes, amounts, physical properties, and so forth used in the specification and claims arc to be understood as being modified by the term “about”. Accordingly, unless indicated to the contrary, the numerical parameters set forth in the specification and claims are approximations that can vary depending on the desired properties sought to be obtained by those skilled in the art utilizing the teachings of the present application.

As used in this specification and the appended claims, the singular forms “a”, “an” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower”, “upper”, “beneath”, “below”, “above”, and “on top”, if used herein, are utilized for ease of description to describe spatial relationships of an element(s) to another. Such spatially related terms encompass different orientations of the device in use or operation in addition to the particular orientations depicted in the figures and described herein. For example, if a cell depicted in a figure is turned over or flipped over, portions previously described as below or beneath other elements would then be above those other elements.

As used herein, when an element, component or layer for example is described as forming a “coincident interface” with, or being “on”, “connected to”, “coupled with” or “in contact with” another element, component, or layer, it can be directly on, directly connected to, directly coupled with, in direct contact with, or intervening elements, components or layers may be on, connected, coupled, or in contact with the particular element, component or layer, for example. When an element, component, or layer for example is referred to as being “directly on”, “directly connected to”, “directly coupled with”, or “directly in contact with” another element, there are no intervening elements, components or layers for example.

As used herein, the term “microstructure” or “microstructured” refers to surface relief features that have at least one dimension that is less than one millimeter. In many embodiments the surface relief features have at least one dimension that is in a range from 50 nanometers to 500 micrometers.

1. A microstructured article, comprising:
a nanovoided layer having a microstructured first major surface and a second major surface opposing the first major surface, the nanovoided layer comprising a polymeric binder and a plurality of interconnected voids; and
a polymeric resin layer disposed on the microstructured first major surface or on the second major surface.

2. The article of claim 1, wherein the nanovoided layer further includes nanoparticles.

3. (canceled)

4. The article of claim 1, wherein the nanovoided layer has an index of refraction in a range from 1.15 to 1.35.

5. The article of claim 1, wherein the polymeric binder is formed from a multifunctional acrylate and a polyurethane oligomer.

6. The article of claim 1, wherein the microstructured first major surface comprises cube corner structures, lenticular structures, or prism structures.

7-8. (canceled)

9. The article of claim 1, wherein the polymeric resin layer is disposed on the microstructured first major surface, and wherein the polymeric resin layer comprises a polymeric material that penetrates into the nanovoided layer.

10. The article of claim 1, wherein the polymeric resin layer is a viscoelastic layer.

11-12. (canceled)

13. The article of claim 1, wherein the polymeric resin layer is disposed on the microstructured first major surface and forms a coincident interface with the microstructured first major surface.

14. The article of claim 13, further comprising an optical element disposed on the second major surface.

15. (canceled)

16. The article of claim 14, wherein the optical element comprises a multilayer optical film, a polarizing layer, a reflective layer, a diffusing layer, a retarder, a liquid crystal display panel, or a light guide.

17-19. (canceled)

20. The article of claim 1, wherein the microstructured first major surface has associated therewith a structure height of at least 15 micrometers and an aspect ratio greater than 0.3, and wherein the nanovoided layer has a void volume fraction in a range from 30 to 55%.

21. The article of claim 1, wherein the microstructured first major surface has associated therewith a structure height of at least 15 micrometers and an aspect ratio greater than 0.3, and wherein the nanovoided layer has a refractive index in a range from 1.21 to 1.35.

22. A method, comprising:
disposing a coating solution onto a substrate, the coating solution comprising a polymerizable material and a solvent;
polymerizing the polymerizable material while the coating solution is in contact with a microreplication tool to form a microstructured layer; and
removing solvent from the microstructured layer to form a nanovoided microstructured article.

23-24. (canceled)

25. The method of claim 22, wherein the polymerizable material comprises a multifunctional acrylate and a polyurethane oligomer.

26. The method of claim 22, wherein the substrate is a light transmissive film, wherein the coating solution further comprises a photoinitiator, and wherein the polymerizing includes transmitting light through the substrate while the coating solution is in contact with the microreplication tool.

27-30. (canceled)

31. The method of claim 1, wherein the nanovoided microstructured article has a microstructured surface characterized by a structure height of at least 15 micrometers and an aspect ratio greater than 0.3, and wherein the coating solution has a wt % solids in a range from 45 to 70%.

32. A microstructured article, comprising:
a nanovoided layer having a microstructured first major surface and a second major surface opposing the first major surface, the nanovoided layer comprising a polymeric binder and a plurality of interconnected voids; and
a polymeric resin layer disposed on the microstructured first major surface;
wherein the polymeric resin layer comprises a polymeric material that penetrates into the nanovoided layer.

33-34. (canceled)

35. The article of claim 32, wherein the nanovoided layer is characterized by an average void diameter, and wherein penetration of the polymeric material into the nanovoided layer is characterized by an interpenetration depth in a range from 1 to 10 average void diameters.

36. The article of claim 32, wherein penetration of the polymeric material into the nanovoided layer is characterized by an interpenetration depth of no more than 10 micrometers.

37. (canceled)

38. A microstructured article, comprising:
a nanovoided layer having a microstructured first major surface and a second major surface opposing the first major surface, the nanovoided layer comprising a polymeric binder and a plurality of interconnected voids; and
an inorganic layer disposed on the microstructured first major surface or on the second major surface.

39. (canceled)
